(19) United States
(12) Patent Application Publication
(10) Pub. No.: US 2017/0132571 A1
(43) Pub. Date: May 11, 2017

(54) WEB-BASED EMPLOYMENT APPLICATION SYSTEM AND METHOD USING BIODATA

(71) Applicant: Harley V. Stock, Plantation, FL (US)

(72) Inventor: Harley V. Stock, Plantation, FL (US)

(21) Appl. No.: 15/155,035

(22) Filed: May 15, 2016

Related U.S. Application Data
(60) Provisional application No. 62/162,414, filed on May 15, 2015.
(60) Provisional application No. 62/168,445, filed on May 29, 2015.

(51) Int. Cl. G06Q 10/10

(52) U.S. Cl. CPC G06Q 10/1053

(57) ABSTRACT

An employment application system and method for analyzing an applicant's behavior over time in a plurality of categories, is presented herein. The system/method includes a web-based dynamic application system for generating a plurality of questions and dynamically presenting the plurality of questions to an applicant based upon answers provided thereto. At least some of the plurality of questions include inquires relative to biodata, or data corresponding to the applicant's behavior over a period of time. The system/method further includes processing the applicant's answers and generating a report based thereon, the report comprising a narrative description of the questions/answers provided relative to the application system.

### CROSS-REFERENCE TO RELATED APPLICATION

This application is related to and claims priority to: U.S. Provisional Patent Application Ser. No. 62/162,414, filed May 15, 2015, entitled WEB-BASED EMPLOYMENT APPLICATION SYSTEM AND METHOD USING BIODATA; and U.S. Provisional Patent Application Ser. No. 62/168,445, filed May 29, 2015, entitled WEB-BASED SMART APPLICATION, the entirety of all of which is incorporated herein by reference.

### STATEMENT REGARDING FEDERALLY SPONSORED RESEARCH OR DEVELOPMENT

n/a

### FIELD OF THE INVENTION

The present invention is related to employment application systems, assessments, and reports, and methods of use thereof.

### BACKGROUND OF THE INVENTION

Typical employment applications include several information sections for an applicant to fill out. Such sections typically include a number of static, blank information fields related to past employment history, education and training, criminal history, or the like. Such typical application forms merely capture and convey the exact information that the applicant provided, and fail to identify applicants who are intentionally distorting their answers on the application, or provide any insight into behavioral history and potential issues related thereto. Psychological literature, however, suggests a significant number of applicants lie on their application, and it has been estimated that falsification of credentials among job candidates across the board occurs in about 30% of applications and 15% of applications of candidates for higher level positions. Uncertain economic times can further increase an applicant's propensity to distort his/her responses. Traditional, static applications have no way of either identifying the distortion at the time of the application process or segregating the specific area of distortion. The present disclosure provides improved systems and methods for dynamically providing questions to an applicant, while capturing and analyzing various metrics to identify distorted or less-than-candid responses to increase the likelihood of accurate evaluation, and generating a unique narrative report for the recipient of the application.

### SUMMARY OF THE INVENTION

The present invention includes a computer-based method for acquiring and assessing applicant biodata, comprising: presenting a first biodata question to an applicant; receiving a response to the first biodata question from the applicant; presenting a second biodata question to the applicant, wherein the second biodata question is selected from a plurality of stored biodata questions, and wherein the selection is based at least in part on the applicant's response to the first biodata question; receiving a response to the second biodata question from the applicant; and calculating a veracity or candidness score for each of the responses to the first and second biodata question, wherein the calculation is based at least in part on at least one of i) a time duration for the applicant to respond; ii) a predetermined score assigned to an applicant's provided response; and iii) a comparison between the response to the first biodata question and the response to the second biodata question.

The method may include, for presenting the first biodata questions, transmission of the first biodata question across a network, and receiving the response may include receiving information transmitted across the network. The first and second biodata questions may each refer to at least one of employment history, educational history, residential history, military history, legal history, and financial history. The method may include generating a narrative report based at least in part on the responses to the first and second biodata questions and the veracity or candidness score. Presenting each of the first and second biodata questions may include presenting a plurality of predetermined answers for the applicant to select, where each of the predetermined answers may have an assigned scoring value different from each of the other predetermined answers.

Calculating a veracity or candidness score based at least in part on a comparison between the responses to the first and second biodata questions may include comparing whether the assigned scoring value for the response to the first biodata question matches the assigned scoring value for the response to the second biodata questions. The method may include generating a narrative report based at least in part on the assigned scoring value for each of the selected responses to the first and second biodata questions. Calculating the veracity or candidness score may include calculating or assessing all of i) a time duration for the applicant to respond; ii) a predetermined score assigned to an applicant's provided response; and iii) a comparison between the response to the first biodata question and the response to the second biodata question, or individual combinations thereof. Calculating a veracity or candidness score based at least in part on a time duration for the applicant to respond may include calculating an average response time across a plurality of biodata questions; and comparing a response time the applicant takes for a specific biodata question to the calculated average response time. Calculating a veracity or candidness score based at least in part on a time duration for the applicant to respond may include comparing a response time the applicant takes for a specific biodata question to a predefined response time threshold.

A system for acquiring and assessing applicant biodata is provided, including a biodata question database storing a plurality of biodata questions; a user interface in communication with the biodata question database, the user interface configured to present biodata questions to an applicant and receive responses to the biodata questions from the applicant; and a processor in communication with the user interface and the biodata question database, wherein the processor is programmed to: select a first biodata question for presentation to the applicant; receive a response to the first biodata question from the applicant; select a second biodata question for presentation to the applicant, wherein the second biodata question is selected from the plurality of stored biodata questions, and wherein the selection is based at least in part on the applicant's response to the first biodata question; receive a response to the second biodata question from the applicant; and calculate a veracity or candidness score for each of the responses to the first and second biodata question, wherein the calculation is based at least in part on at least one of i) a time duration for the applicant to respond; ii) a predetermined score assigned to an applicant's provided response; and iii) a comparison between the response to the first biodata question and the response to the second biodata question. The first and second biodata questions may each refer to at least one of employment history, educational history, residential history, military history, legal history, and financial history. The processor may be programmed to generate a narrative report based at least in part on the responses to the first and second biodata questions and the veracity or candidness score. Presenting each of the first and second biodata questions may include presenting a plurality of predetermined answers for the applicant to select. Each of the predetermined answers may have an assigned scoring value different from each of the other predetermined answers. Calculating a veracity or candidness score may be based at least in part on a comparison between the responses to the first and second biodata questions includes comparing whether the assigned scoring value for the response to the first biodata question matches the assigned scoring value for the response to the second biodata questions. The processor may be programmed to generate a narrative report based at least in part on the assigned scoring value for each of the selected responses to the first and second biodata questions.

Calculating the veracity or candidness score may include calculating or assessing all or combinations of i) a time duration for the applicant to respond; ii) a predetermined score assigned to an applicant's provided response; and iii) a comparison between the response to the first biodata question and the response to the second biodata question. Calculating a veracity or candidness score based at least in part on a time duration for the applicant to respond may include calculating an average response time across a plurality of biodata questions; and comparing a response time the applicant takes for a specific biodata question to the calculated average response time.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block-diagram of an example of a system constructed in accordance with the principles of the present invention;

FIG. 2 is an illustration of an example of a user interface screen in accordance with the principles of the present invention;

FIGS. 3A-3B are illustrations of additional examples of a user interface screen in accordance with the principles of the present invention;

FIGS. 4A-4B are flow charts of examples of methods of use in accordance with the principles of the present invention;

FIGS. 5A-5AG are illustrations of examples of narrative reports generated in accordance with the principles of the present invention; and

FIG. 6 is an example of a set of biodata questions pertaining to veracity or candidness.

### DETAILED DESCRIPTION OF THE INVENTION

The present disclosure is directed to systems and methods for presenting biodata employment application forms, analyzing the information provided by the applicant, and generating a report and assessment in the form of a narrative for the employer to review. In particular, the present system and methods may include simple-to-use, web-based software tools designed to empower the hiring process by using dynamic application forms that gather information about the applicant, analyzes the responses, and prepares a narrative report based thereon.

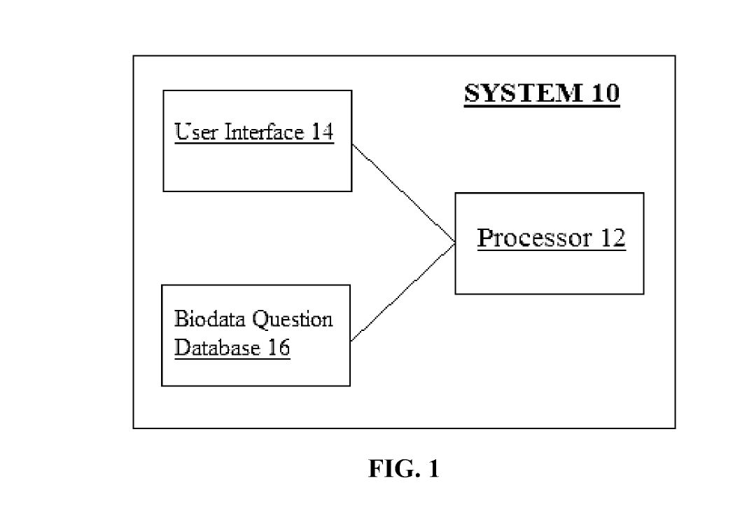

Now to the figures, in which like reference designators refer to like components, FIG. 1 is a block diagram of an example of a system 10 constructed in accordance with principles of the present disclosure, which includes a processor 12 that is configured and operable to perform the various features of the methods and processes disclosed herein. The system 10 generally includes a user interface 14 that enabled the system to receive inputs from, and generate output to, various users, applicants, or clients utilizing the system. The interface may include, for example, one or more visual interfaces as well as input devices, including but not limited to, personal computers, tablets, smart phones, or the like. The system 10 may also include a biodata question database 16 containing a plurality of stored biodata questions that can be accessed as disclosed herein. The processor 12, user interface 14, and the biodata question database 16 may all be in communication with each other, either directly within a single computing device or system, or in communication across one or more networks spanning multiple locations.

A biodata application is different from a traditional application form in many aspects. On a biodata application, individuals are asked to recall or report their typical behaviors or experiences in their current and past work environments. Biodata items are based on the psychological assumption that the person's past behaviors and experiences are a potential predictor of his or her future behavior and experiences. This does not suggest that all future behavior can be predicted by past experiences, but rather that knowledge of previous experiences will allow some prediction of future behavior, given that the individual's prior learning history will make the occurrence of some forms of behavior more probable than others. Responding to these questions, the applicant is asked to recall their typical behavior in, or reactions to, the referenced situation and then select from the available response options the one that best describes the overall pattern of the prior behavior and experiences. Subsequently, the individual's behavioral consistencies to these qualitatively defined development patterns are used to: (a) generate a summary report of the applicant's employment history and (b) provide a structured guide for the applicant interview with highlighted areas of inquiry.

Biodata items can include prior exposure, cognitive/emotional input to an event, internal processing of external information and behavioral outcome. For example, certain biodata item generation may include: review of human development literature, life history interview with incumbents, typical factor loadings of biodata items, known life history correlates on various job specifications, biodata items with known predictive validities, and items generated from the investigator's general psychological knowledge.

Furthermore, the biodata question database 16 may include a plurality of categories and questions that sample and analyze the applicant's behavior over time. In particular, the content of the questions and the sequence of the presentation of the system 10 through the user interface 14 can follow a scientific/research format, with the processor 12 performing a behavior analysis that is compiled into one cohesive narrative, making it easy to integrate into a company's hiring process. The system 10 and methods of use thereof also make the company's hiring process and hiring decision methodology defensive and transparent in the event of a legal challenge. Idiosyncratic tendencies of interpretation of responses often found in traditional application forms are removed. Accordingly, the systems and methods disclosed herein provide dynamic, web-based application forms that utilize novel algorithms to gather, sort, and analyze biodata supplied by the applicant, and generating a comprehensive narrative report.

For example, the biodata question database 16 of at least one embodiment of the present invention comprises a plurality of questions that are organized or divided into a plurality of categories. Within each category, branching logic is used to guide the applicant through dynamically presented questions adapting to each response provided by the applicant. As an example, some of the categories may include Core Areas, such as: Employment History, Educational History, Residential History and Military History; and Special Areas, such as: Legal History, Financial History and Driving History.

Within the Employment History category, there may be questions relating to the following sub-categories: Job Achievement, Job Length, Self-Rating, Supervisory Rating, Co-Worker Rating, Aggressive Activities, Perceived Success on Job, Perceived Hostility by Others, Behavioral Delinquency/Non-Aggressive, Perceived Injustice (procedural), Perceived Injustice (Distributive), Inappropriate Supervisory Behaviors, Perceived Respect, Co-Worker Relationships, Job History Rejections, Terminations/ForcedResignations, Supervisor Relationships, Social Desirability, Working Relationships, Resource Management, Goal Setting, etc.

Within the Education category, there may be questions relating to the following sub-categories: Achievement, Behavioral Disciplinary Actions, Relationships, Affiliation, Activities, Special Training, Academic Consistency, Academic Disciplinary Action, etc. Within the Military category, there may be questions relating to the following sub-categories: Branch and Length of Service, Disciplinary Actions, Relationships to superior officers, etc. Each of the categories and/or sub-categories may include a unique designated code associated therewith for processing and analyzing by the software.

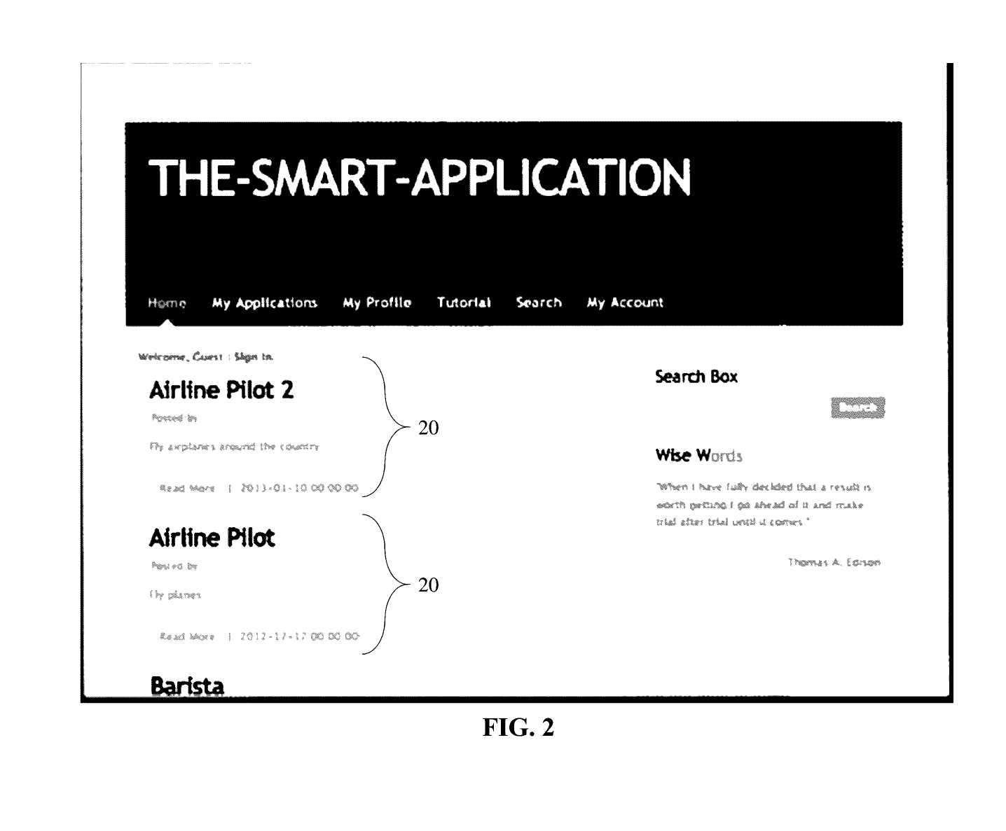

Turning now to FIG. 2, the user interface 14 may allow an applicant to access the system 10 by visiting a webpage, for example. Navigation elements including “Home,” “My Applications,” “My Profile,” “Tutorial,” “Search,” and “My Account” may be provided, as shown. The applicant may update his or her profile, for example, by navigating to “My Profile” or its equivalent. The applicant's application may be organized into a plurality of sections or categories, including, for example, Employment History, Residential History, Military History, Educational History, Legal History, Driving Record, and Financial History.

The applicant may provide information or answer questions within one or more of these categories in order to complete or fill our his or her application. As an example, each category may include a series or set of questions. The responses to the adaptive questions direct the applicant through the process. A list of available jobs 20 may be provided to the applicant for the applicant to browse or search (e.g., using keywords, categories, etc.) When the applicant finds a job he or she wishes to apply for, he or she may begin the application process by clicking “Apply” next to the job, for example. If the applicant's application is complete (or complete enough for that particular job), then system 10 may take questions/answers and/or information provided by the application and provide that as part of the application to the selected job. If the applicant's application is not complete, he or she may be instructed to go back to the application section and complete it. Once the applicant's application is completed or filled out to the extent necessary for the selected job, the system and/or method of at least one embodiment will submit the application to the company associated with the job listing and automatically generate or create a narrative report, as described herein.

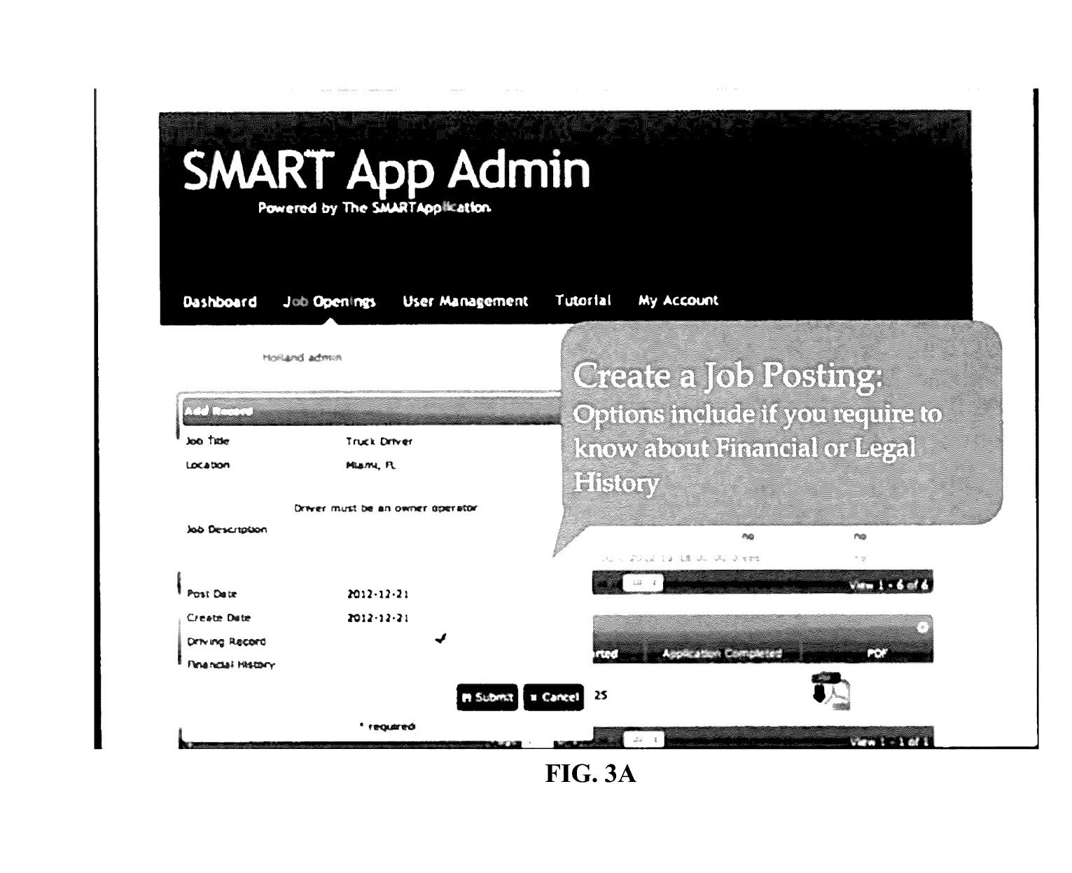

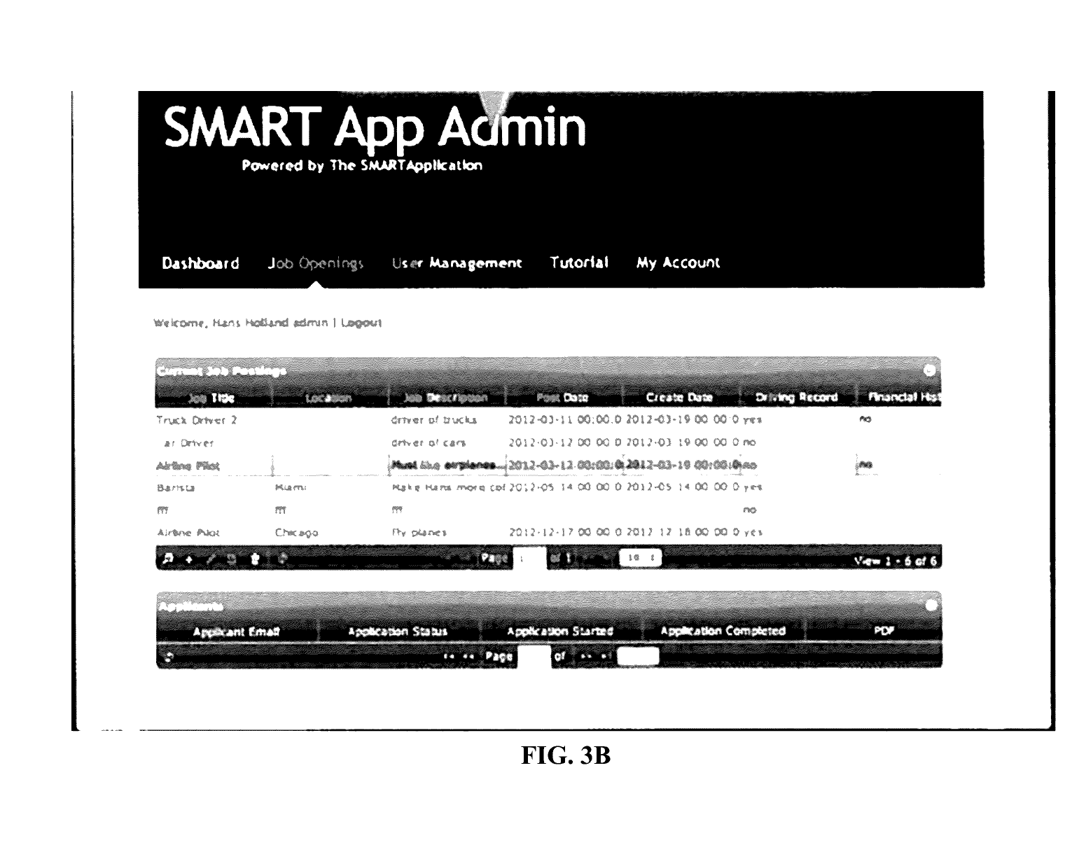

With reference to FIGS. 3A-3B, the company, for example, the HR department of a company, may log into the system and create a job listing or job posting. For example, in FIG. 3A, the company representative may optionally select or identify which areas, categories, or topics are necessary or desired for the particular job posting. As an example, the company representative may choose to select or de-select Financial History or Legal History as categories that may or may not be required as part of the application process for that job posting.

In FIG. 3B, an exemplary screenshot is shown allowing the company representative to access and view reports and narratives generated by the system 10 for various applicants that have submitted an application for a particular job posting. Narratives or reports may be reviewed or organized by job posting or by applicant, as desired by the company representative.

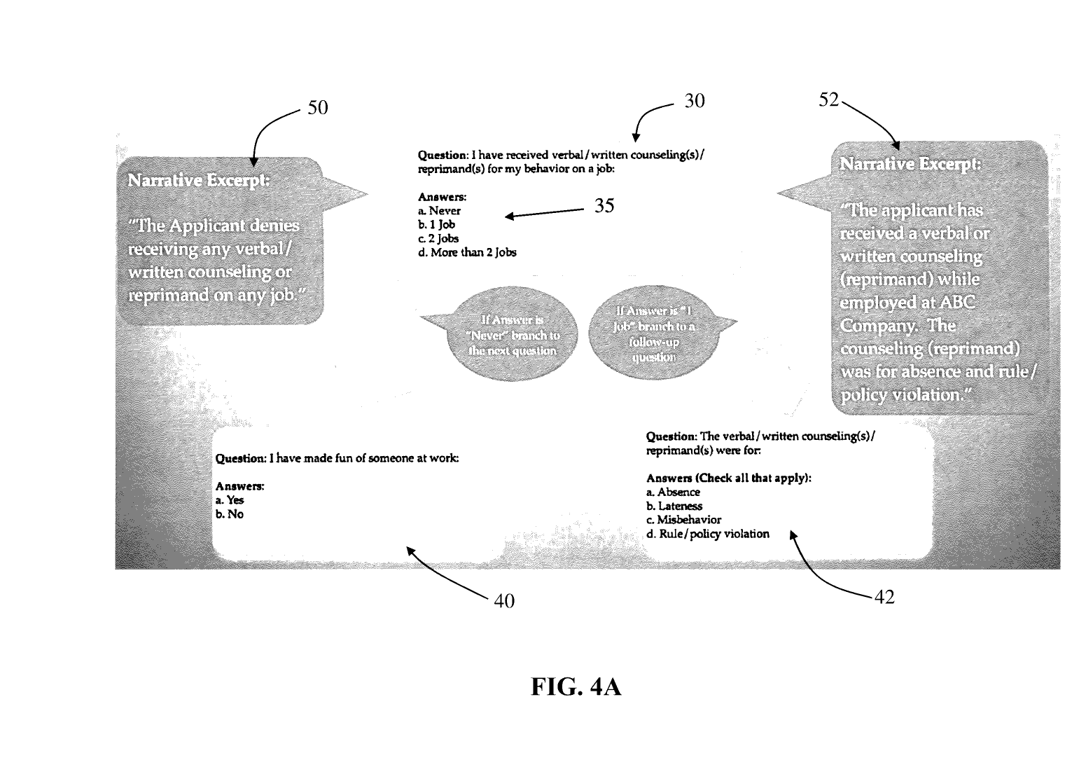

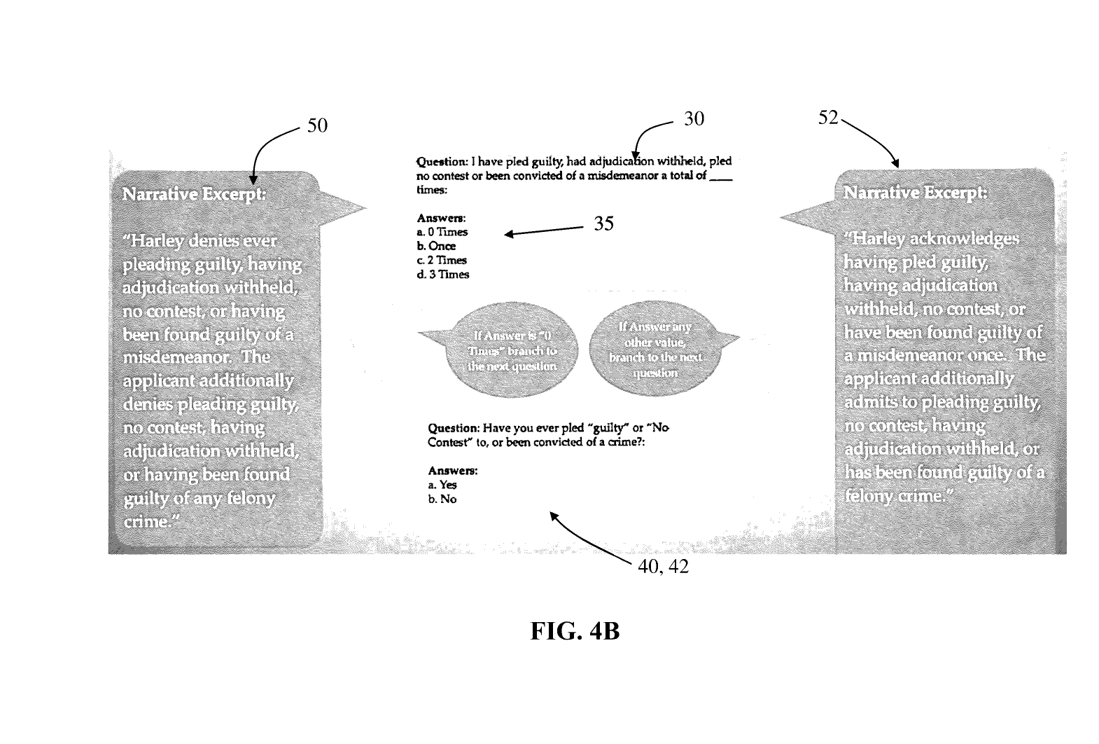

Referring now to FIGS. 4A and 4B, exemplary schematics are shown representing an exemplary question 30, possible answers 35, follow-up or branch questions 40, 42 and exemplary narratives 50, 52 generated based upon the selected answer. For instance, as shown in FIG. 4A, an exemplary question 30 in an Employment History category may include “I have received verbal/written counseling(s)/reprimand(s) for my behavior on a job:” and the possible answers 35 may include, for example: ““a. Never,” “b. 1 job,” “c. 2 jobs,” or “d. More than 2 jobs.” Dynamically presented follow-up or branch questions 40, 42 may be presented depending upon, for example, the answer(s) selected by the applicant. For example, if the applicant selects the answer “a. Never,” then the system/method will automatically present a corresponding follow-up or branch question 40 corresponding to that selected answer. In this example, the corresponding follow-up or branch question 40 may include “I have made fun of someone at work:” with the follow-up or branch answers being “a. Yes” or “b. No.” The corresponding narrative excerpt 50 relating to the applicant's answers that will be added to or made part of the final narrative report may include “The Applicant denies receiving and verbal/written counseling or reprimand on any job.” Accordingly, rather than presenting the question and answer in the written narrative report, the system 10 will transform the answers into a coherent narrative sentence or excerpt that can be easily read, understood and analyzed by the company representative.

Similarly, and still referring to FIG. 4A, if the applicant selects “b. 1 job” to the initial question 30, then the system 10 will automatically present a different corresponding follow-up or branch question 42 corresponding to that selected answer. In this example, the corresponding follow-up or branch question 42 may include “The verbal/written counseling(s)/reprimand(s) were for: “with the follow-up or branch answers being “a. Absence,” “b. Lateness,” “c. Misbehavior,” and/or “d. Rule/Policy violation.” In the event the applicant selects answers “a” and “d,” the corresponding narrative excerpt 52 relating to the applicant's answer(s) that will be added to or made part of the final narrative report may include “The applicant has received a verbal or written counseling (reprimand) while employed at ABC company. The counseling (reprimand) was for absence and rule/policy violation.” Again, rather than presenting the question and answer(s) to the company representative verbatim, the system/method will automatically transform the answers into a coherent narrative sentence or excerpt that can be easily read, understood and analyzed by the company representative.

FIG. 4B illustrates another exemplary set of question(s) 30, 40, 42 and answer(s), as well as exemplary narrative excerpts 50, 52 in accordance with the present invention. For example, within the Legal History category, one question 30 may be “I have plead guilty, had adjudication withheld, pled no contest or been convicted of a misdemeanor a total of times.” Exemplary answers 35 may be “a. 0 times,” “b. Once,” “c. 2 times,” or “d. 3 times.” Depending on the answer, the system/method may automatically branch to one or more different set of question. In this example, a follow-up or branch questions 40, 42 may include “Have you ever pled ‘guilty’ or ‘no contest’ to, or been convicted of a crime?” Potential follow-up answers may be “a. Yes” or “b. No.” for example.

Depending on the answer(s) selected, the system 10 will automatically generate a narrative describing or representing the question/answer sequence. For example, one narrative based on the questions/answers in FIG. 3B may be “Harley denies ever pleading guilty, having adjudication withheld, no contest or having been found guilty of a misdemeanor. The applicant additionally denies pleading guilty, no contest, having adjudication withheld, or having been found guilty of a felony crime.” Another exemplary narrative based on the questions/answers in FIG. 4B may be “Harley acknowledges having pled guilty, having adjudication withheld, no contest or having been found guilty of a misdemeanor once. The applicant additionally admits to pleading guilty, no contest, having adjudication withheld, or has been found guilty of a felony crime.”

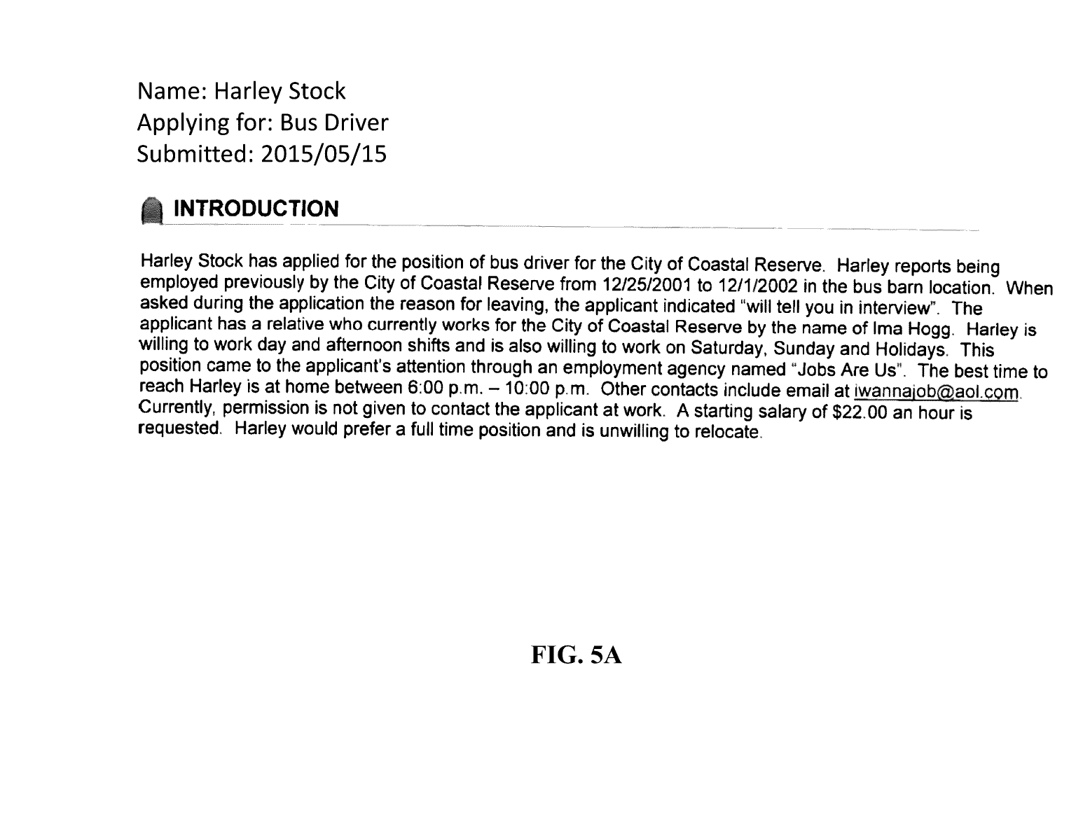

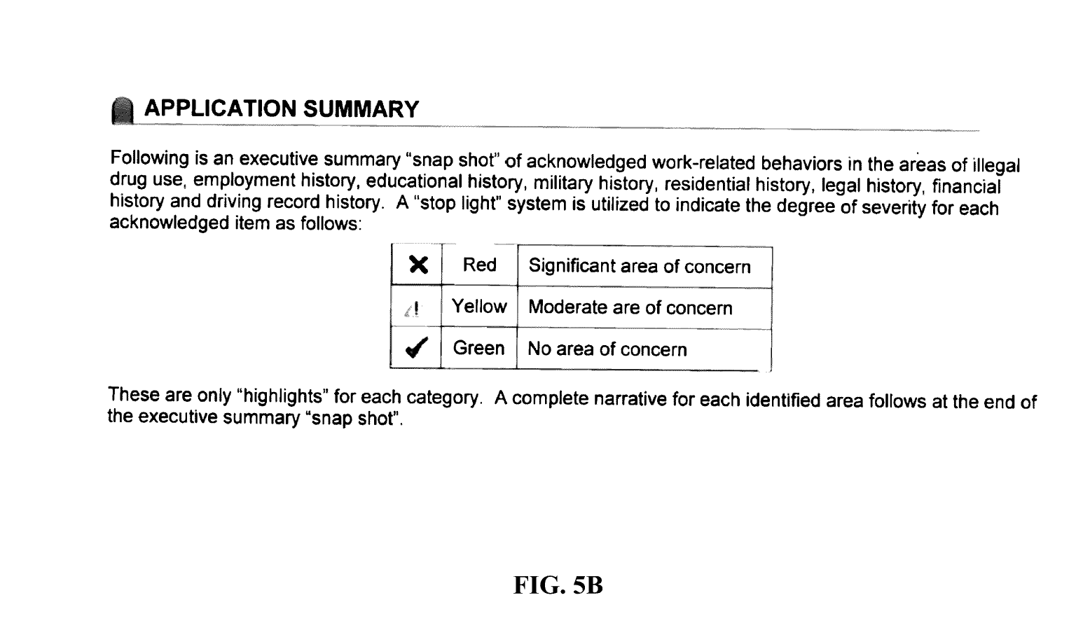

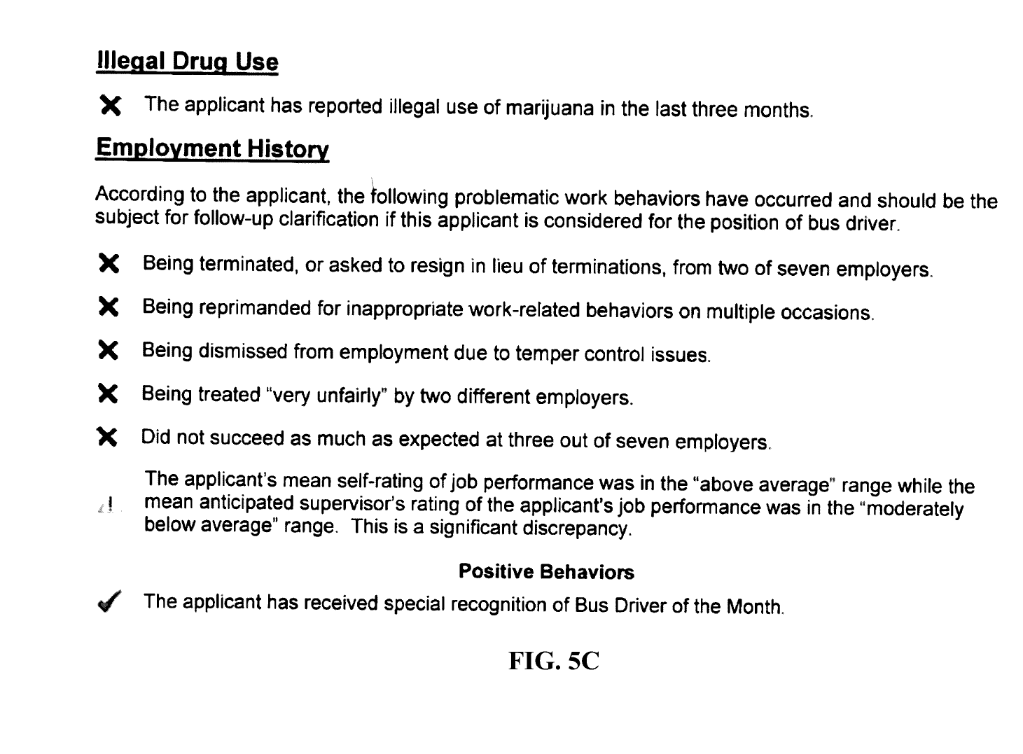

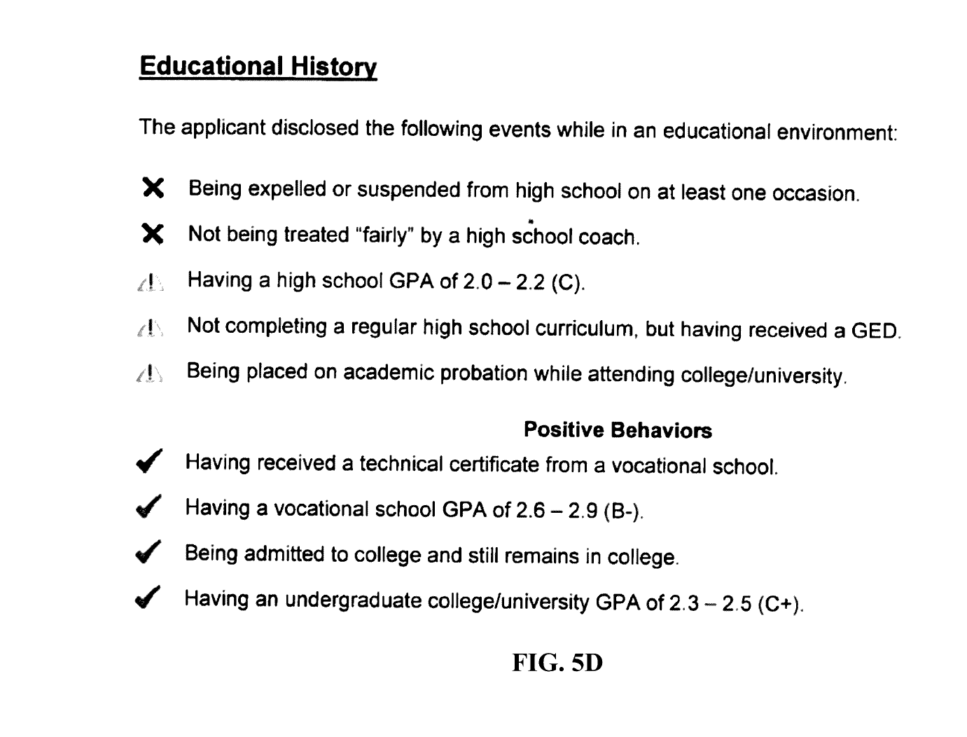

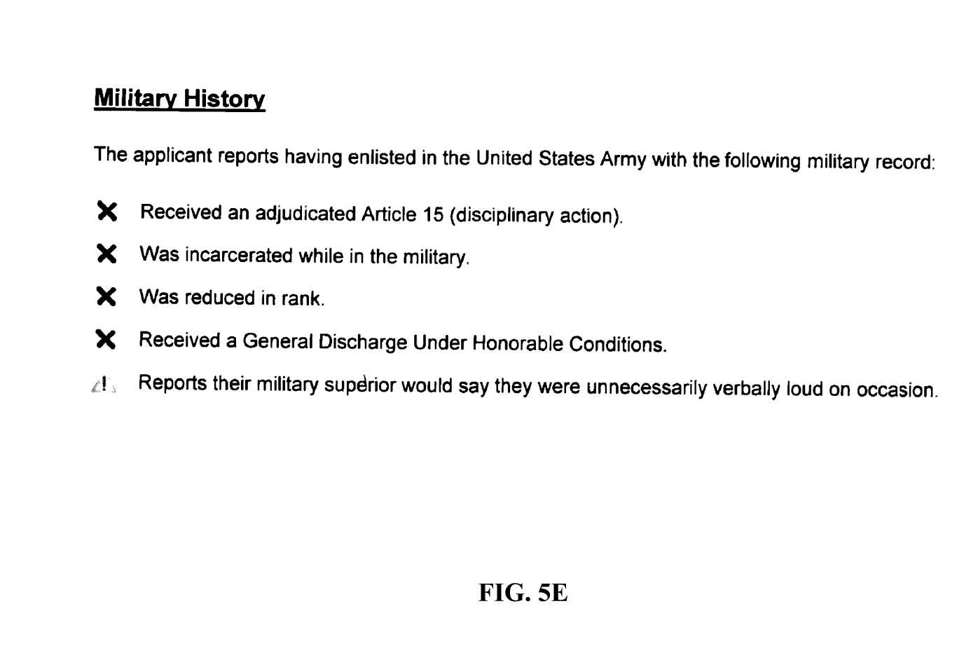

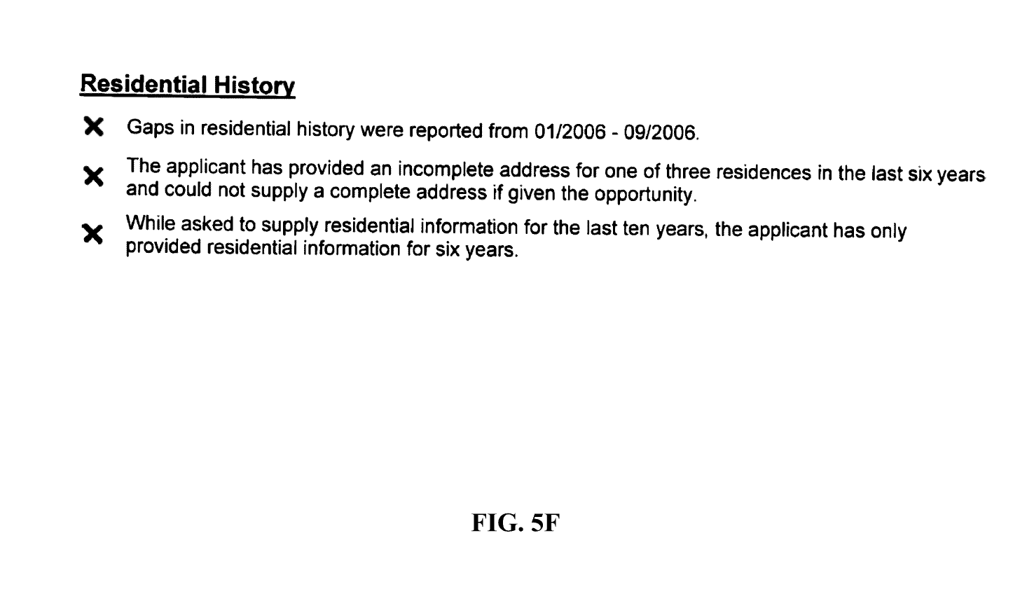

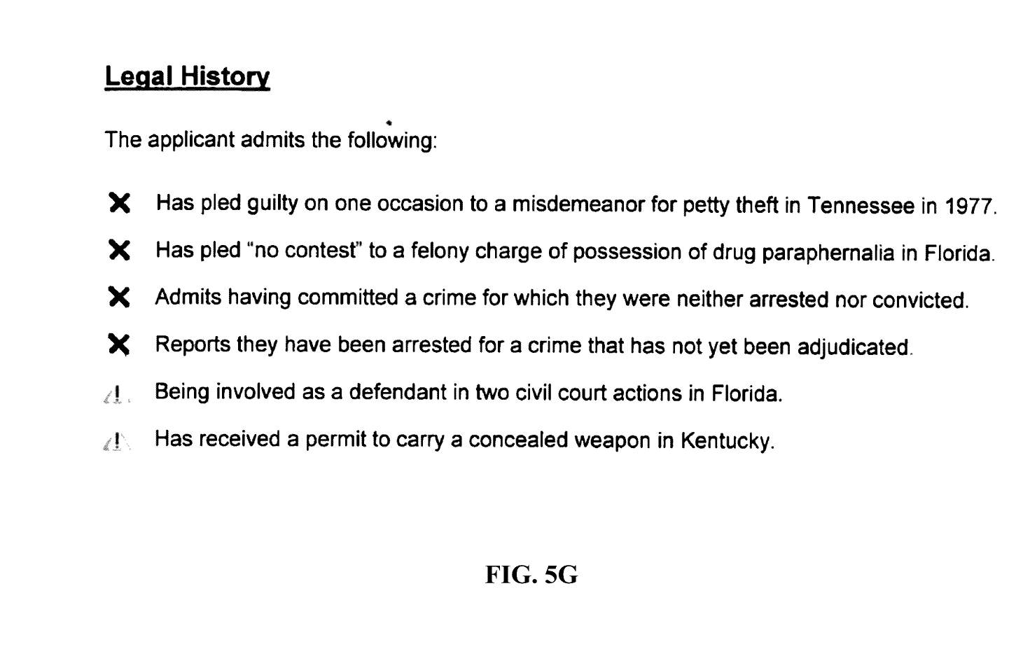

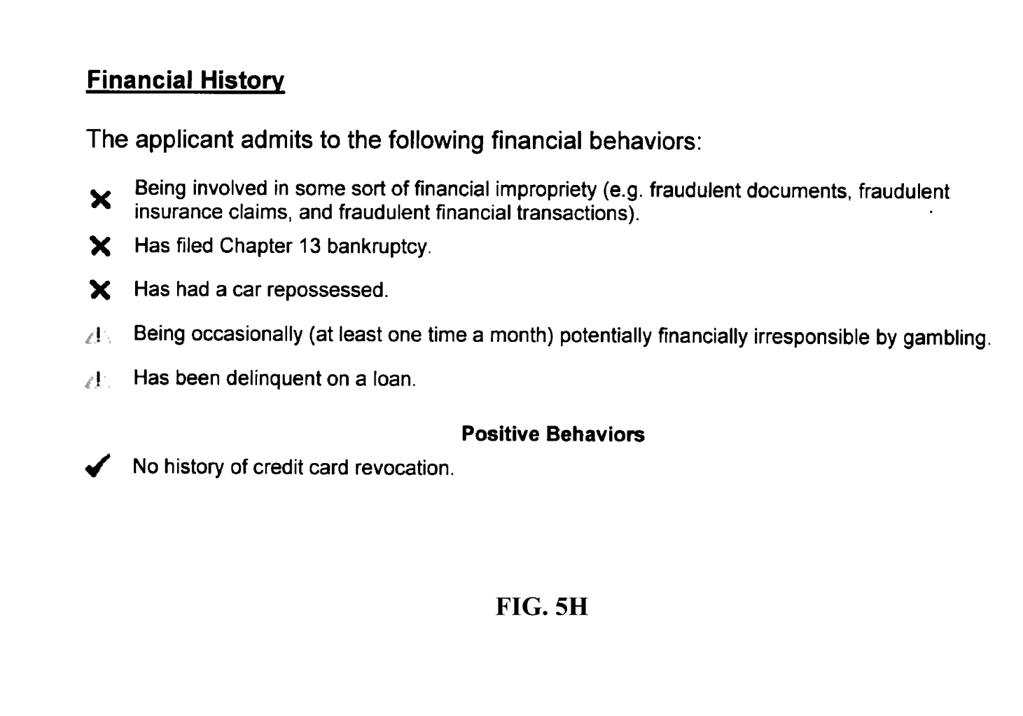

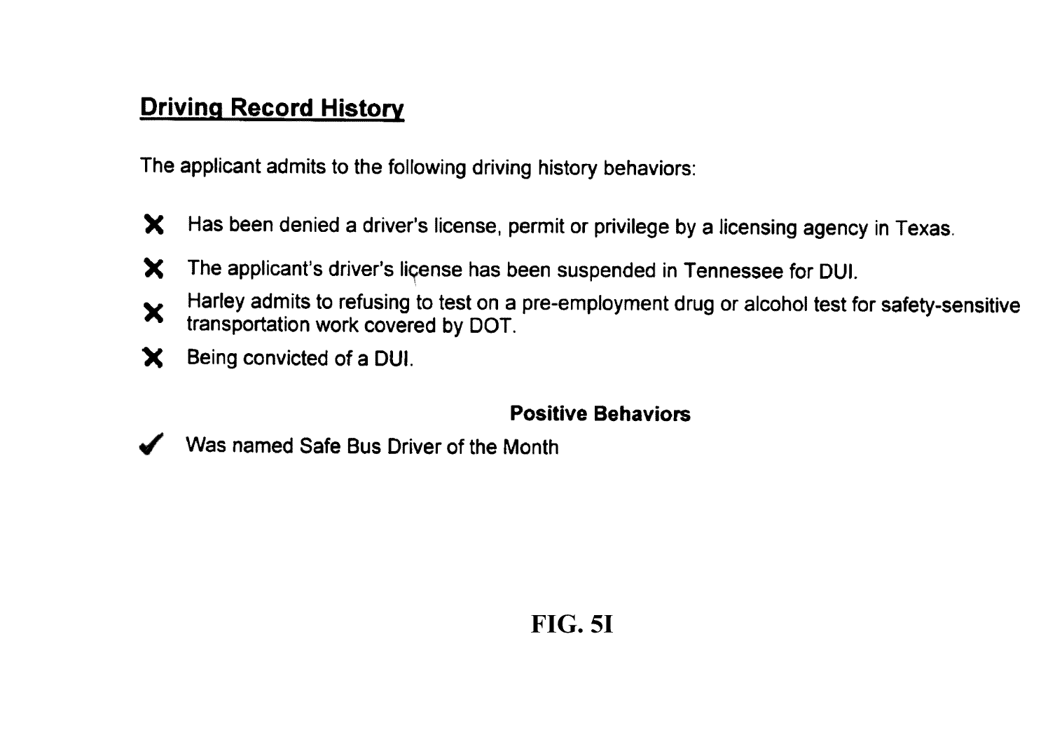

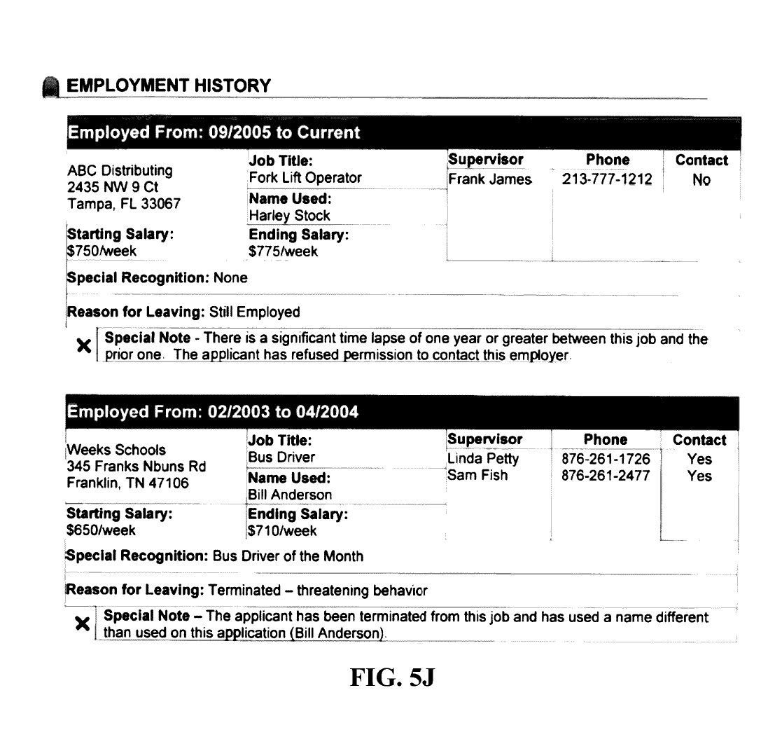

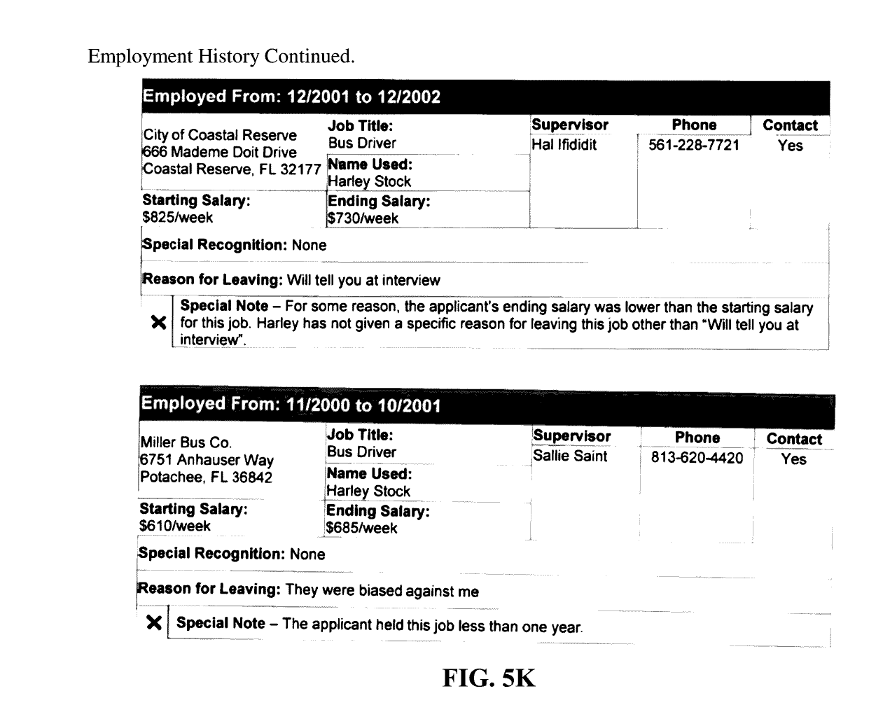

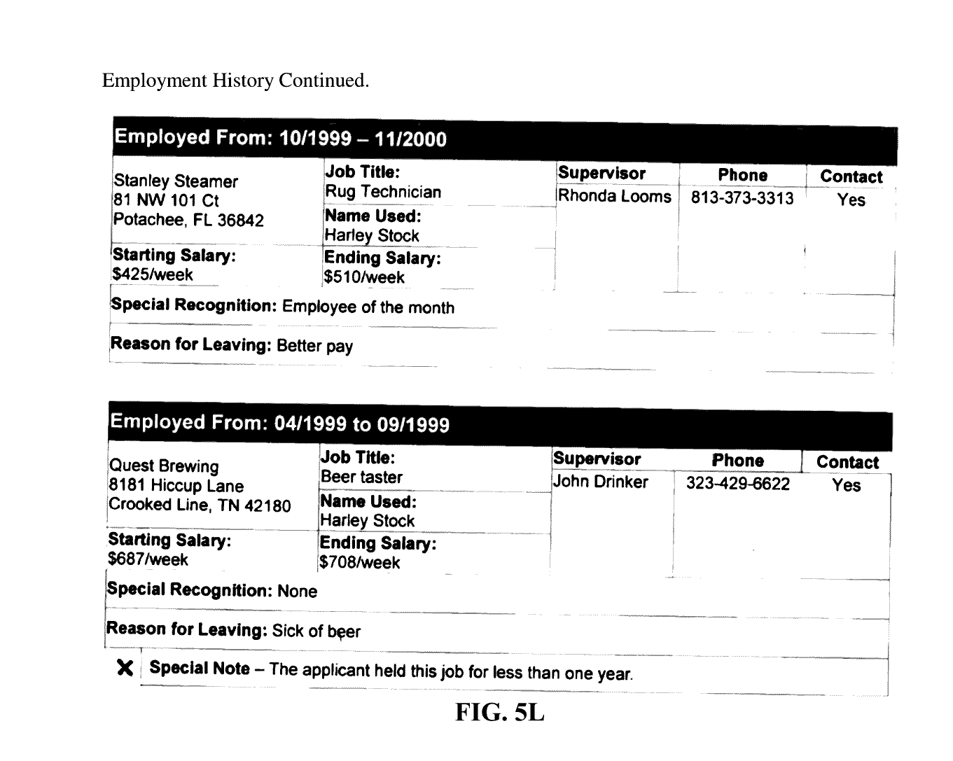

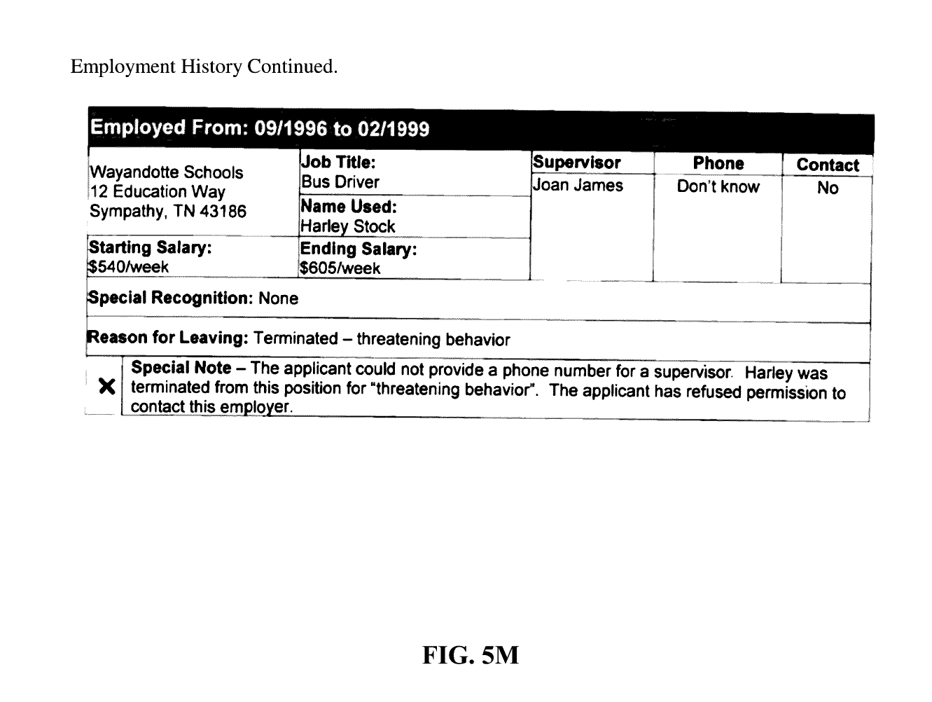

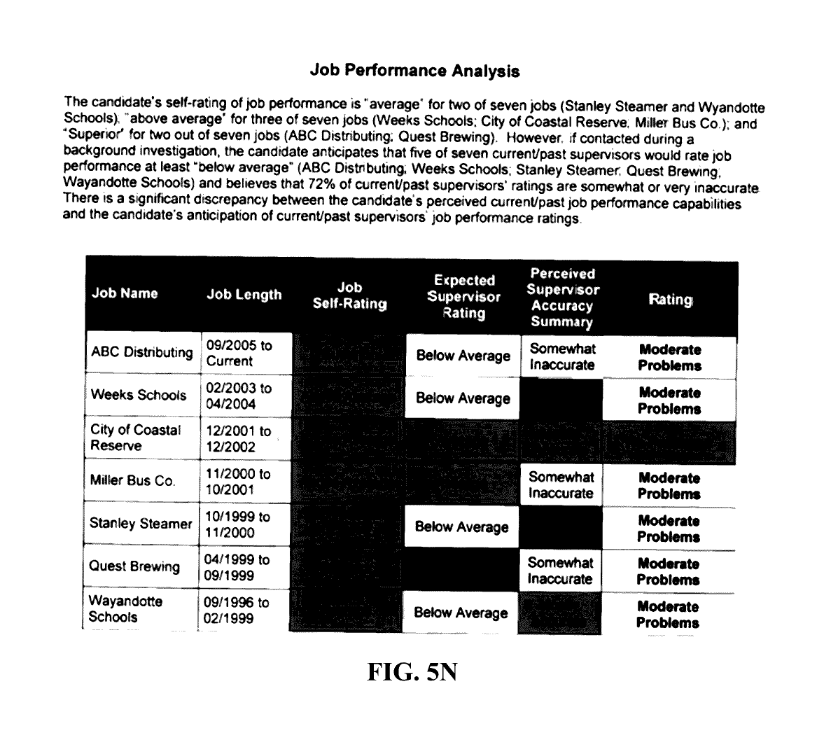

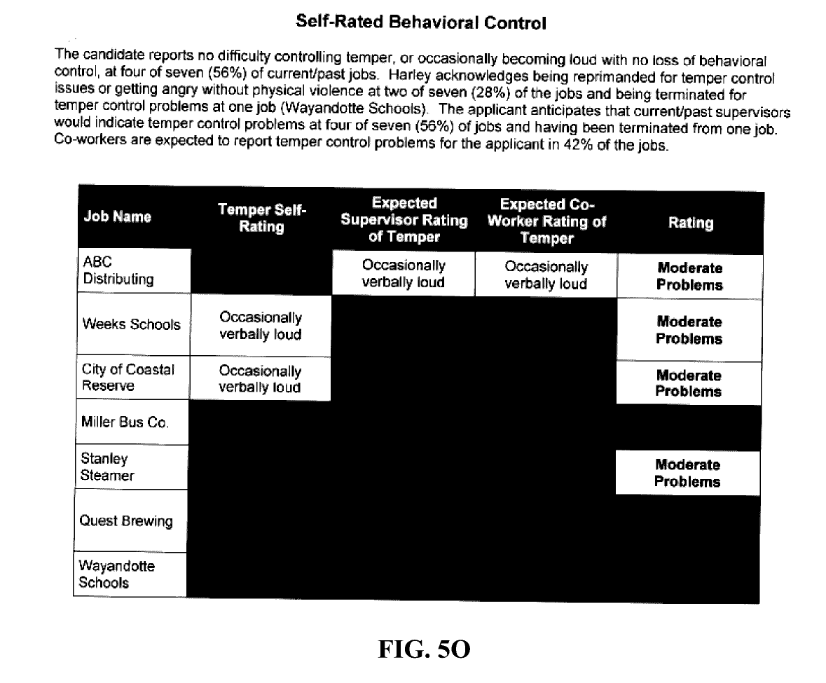

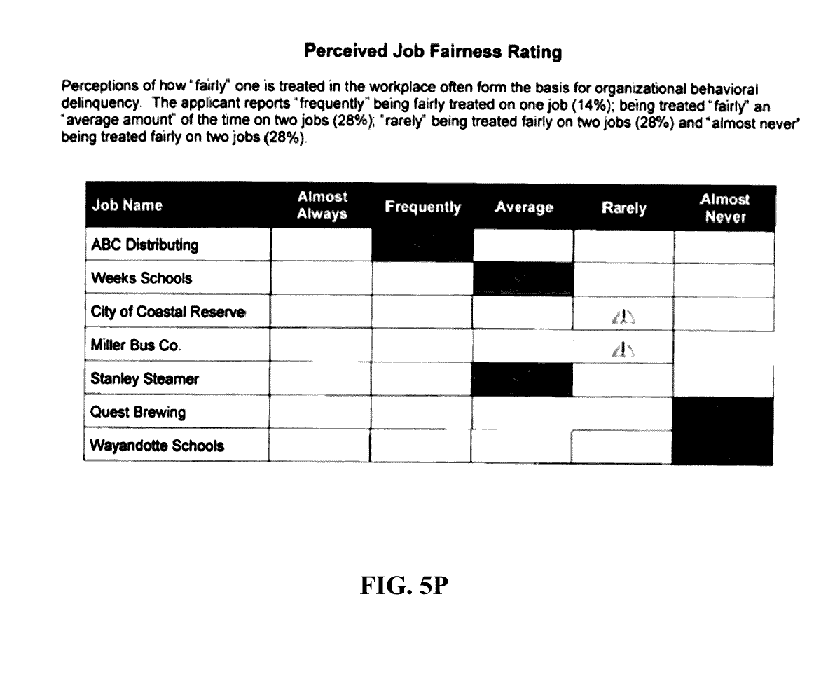

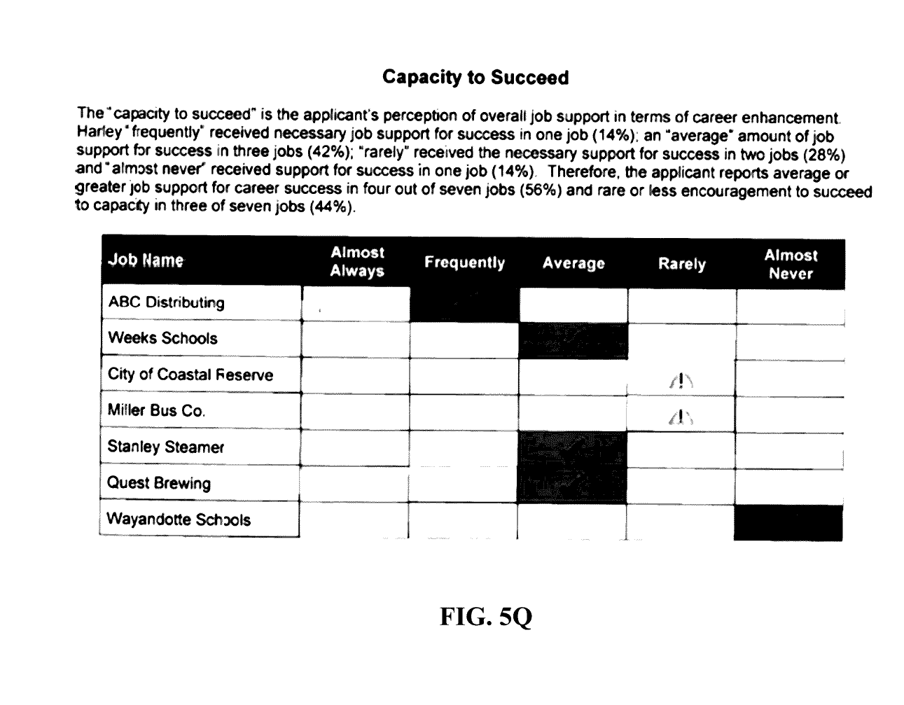

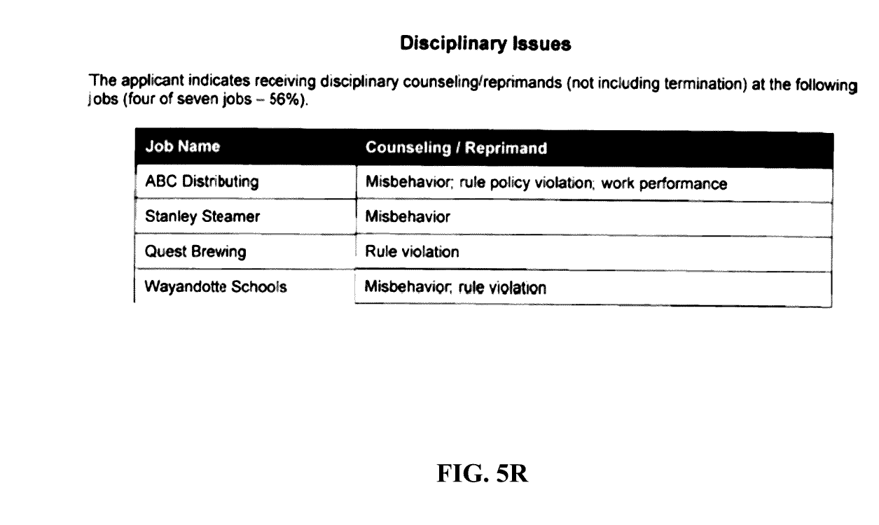

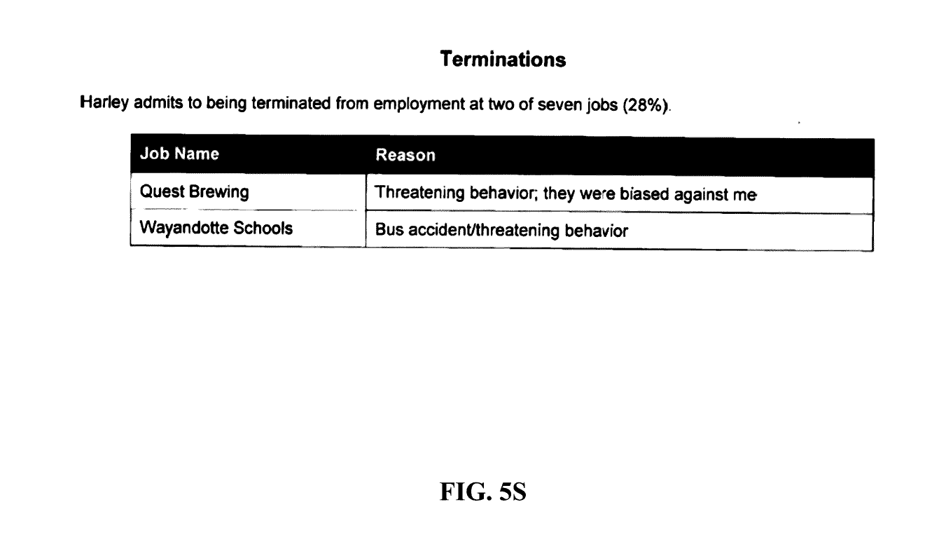

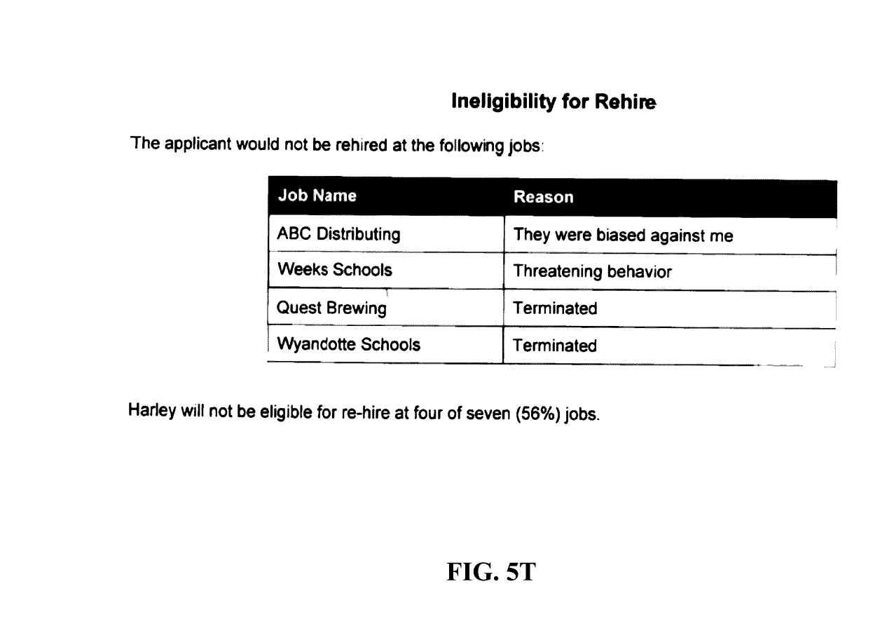

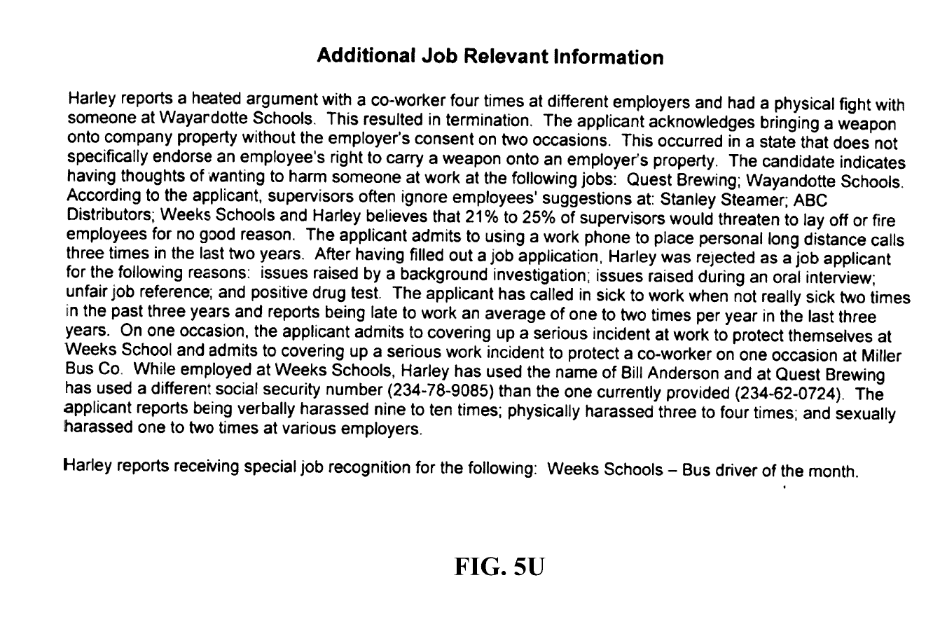

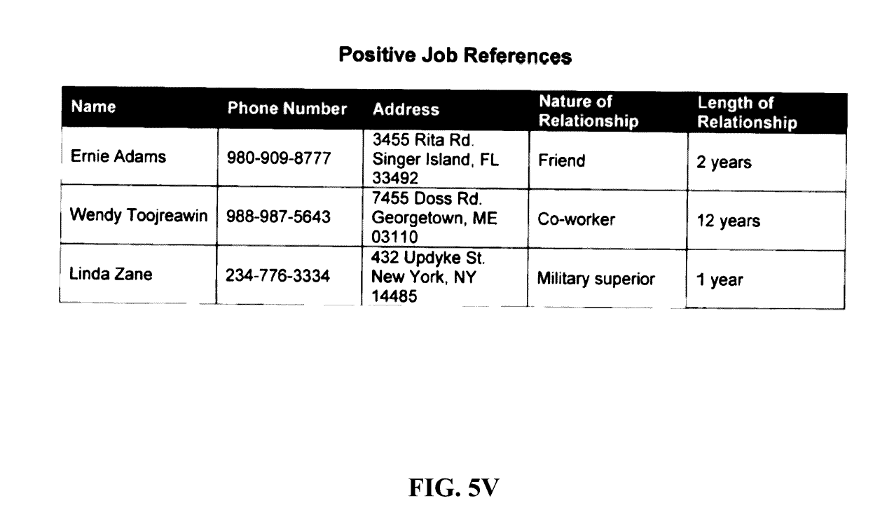

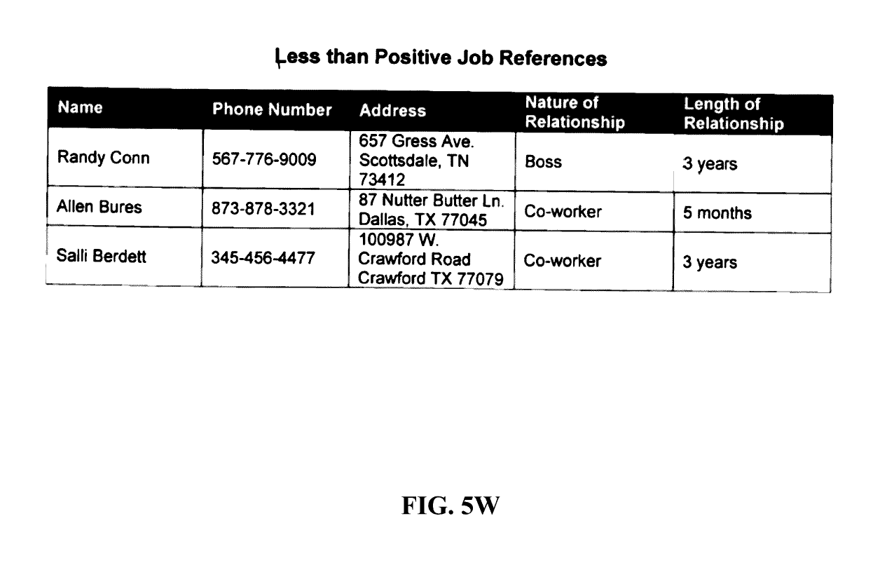

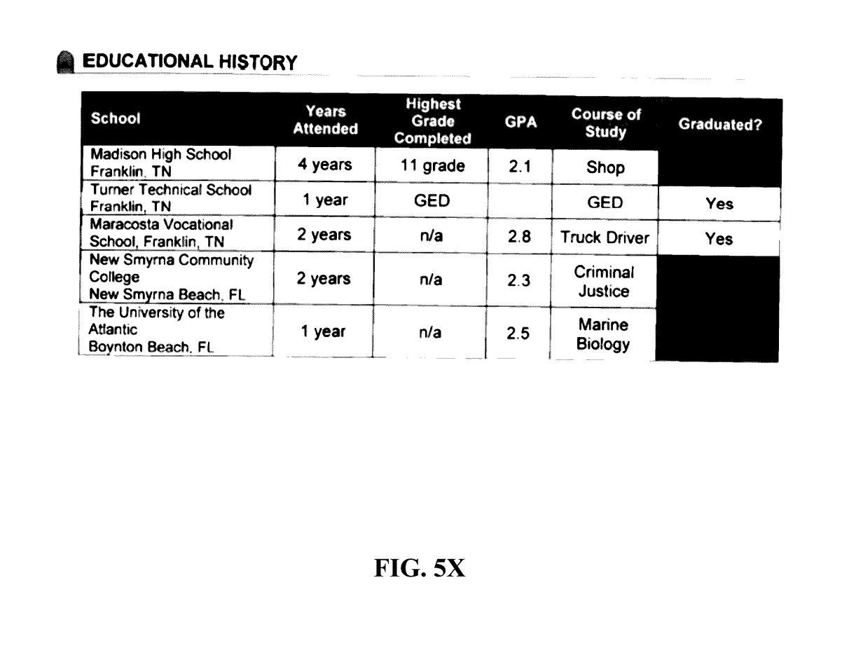

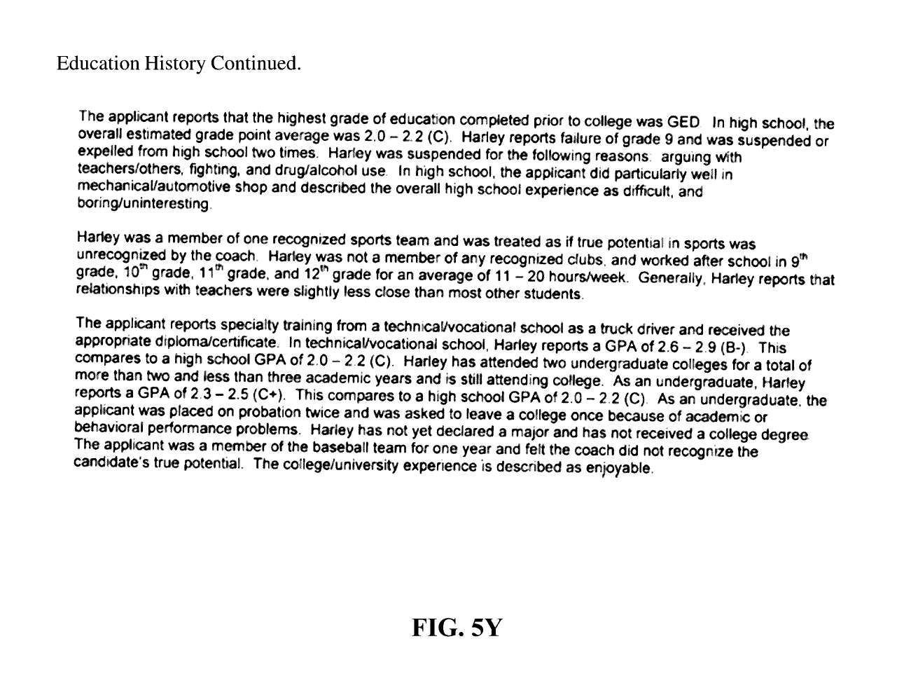

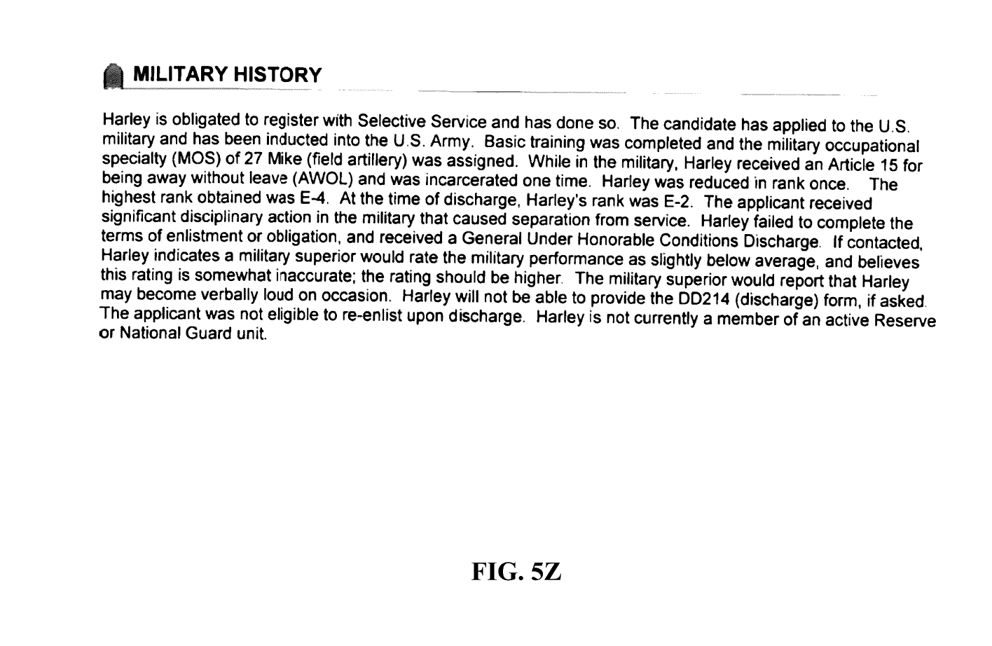

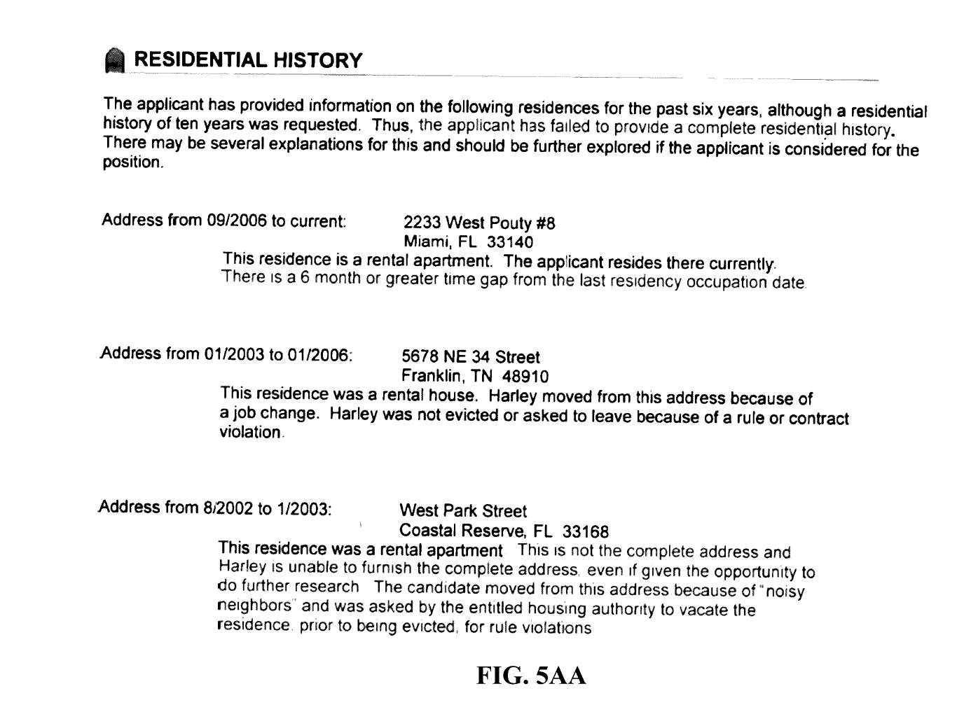

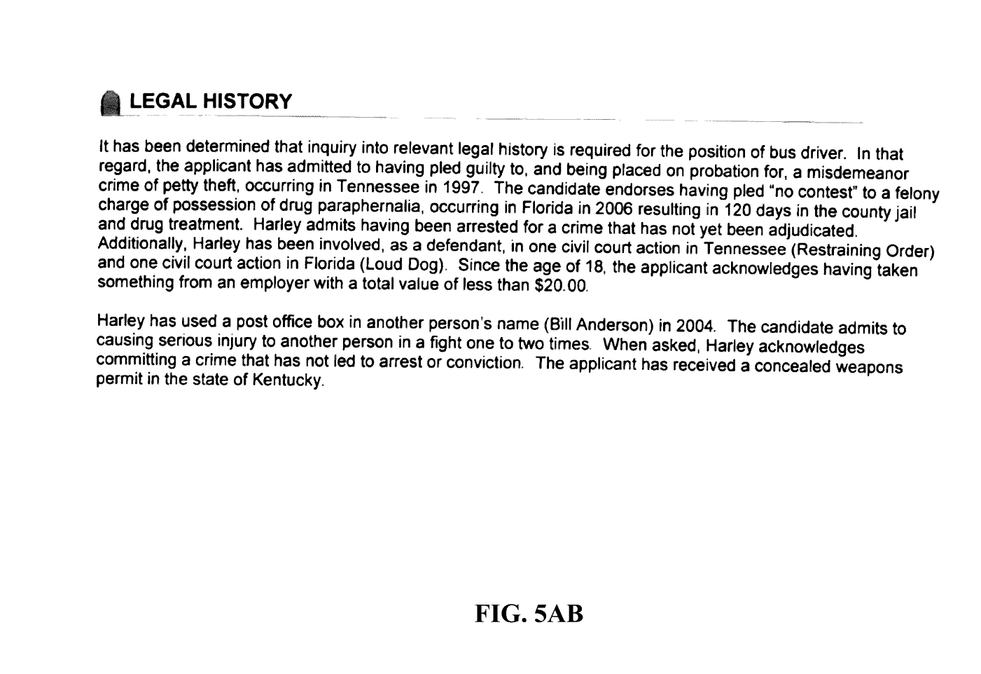

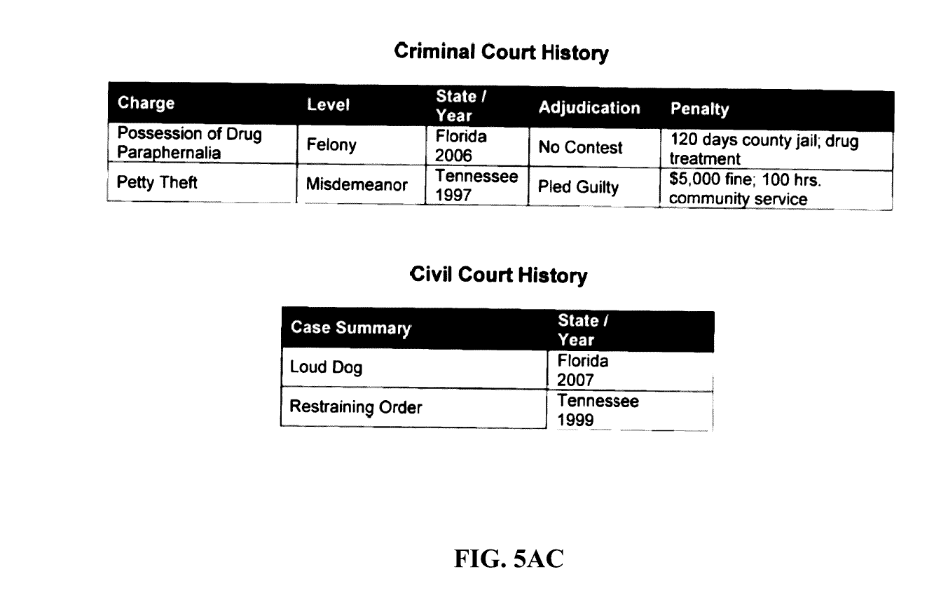

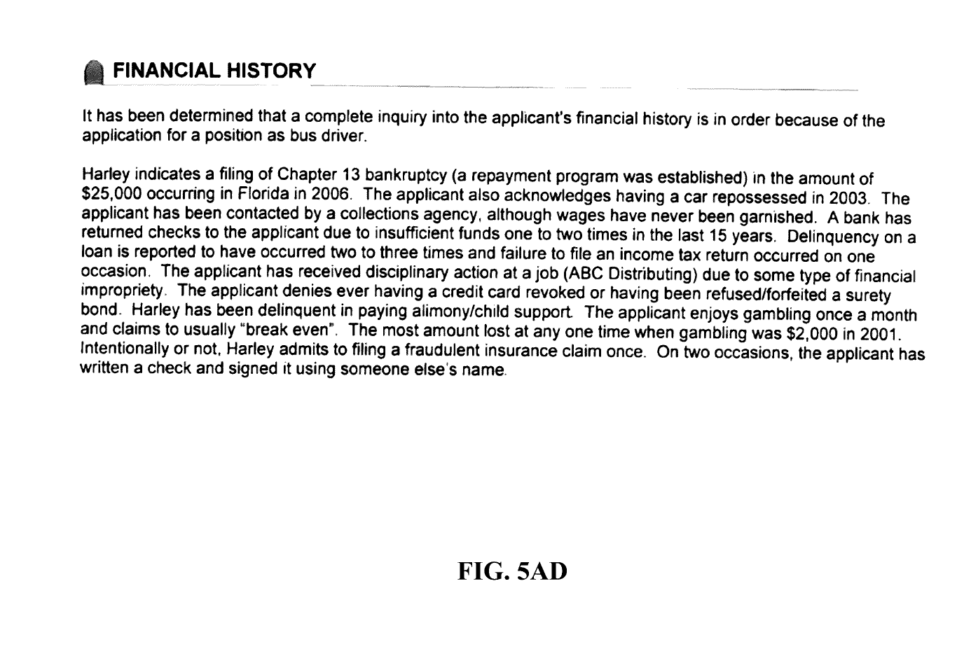

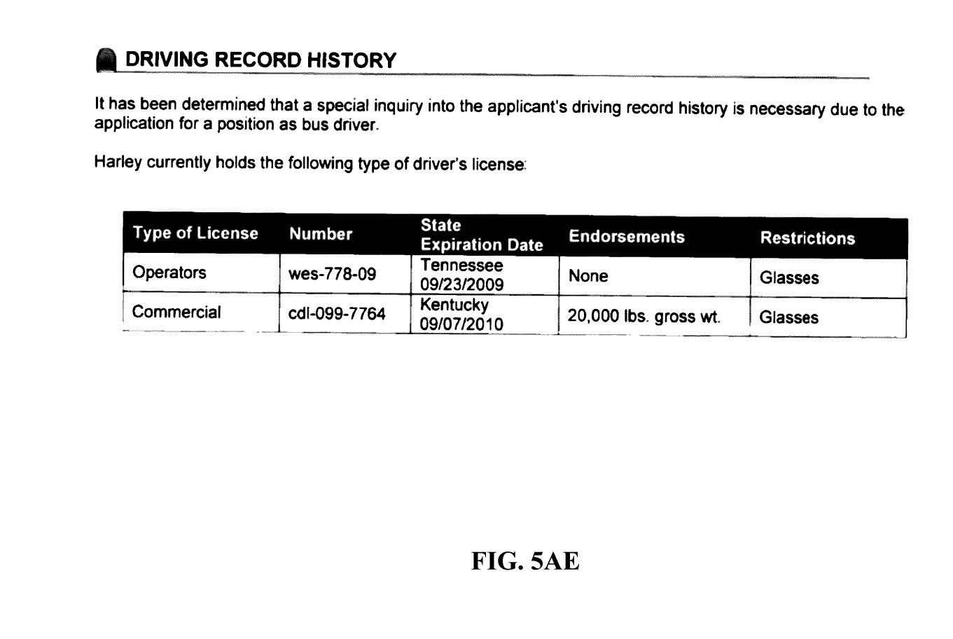

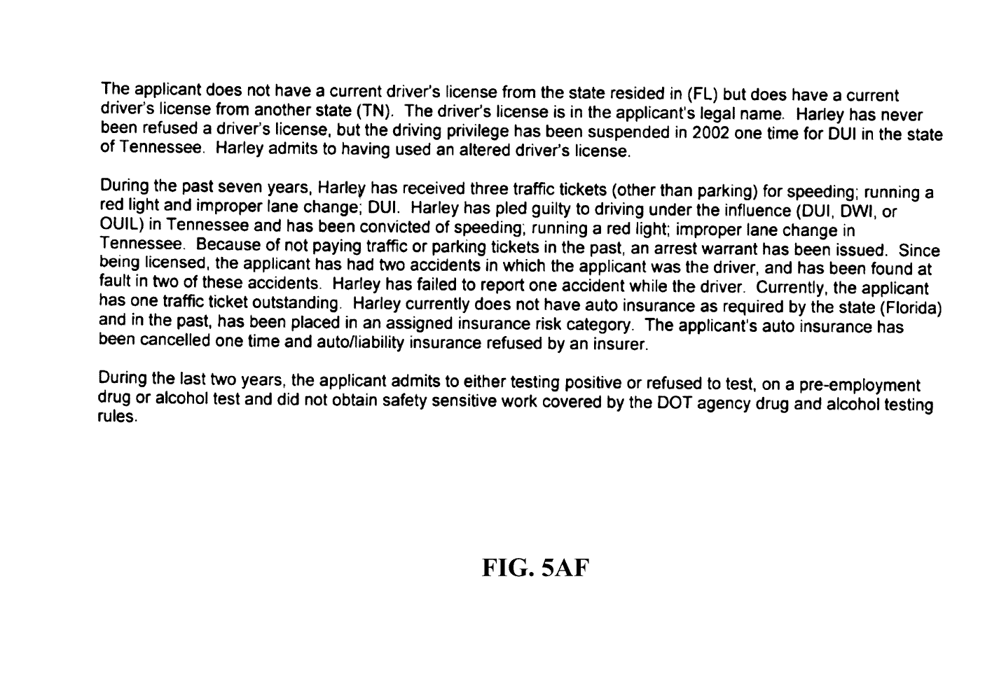

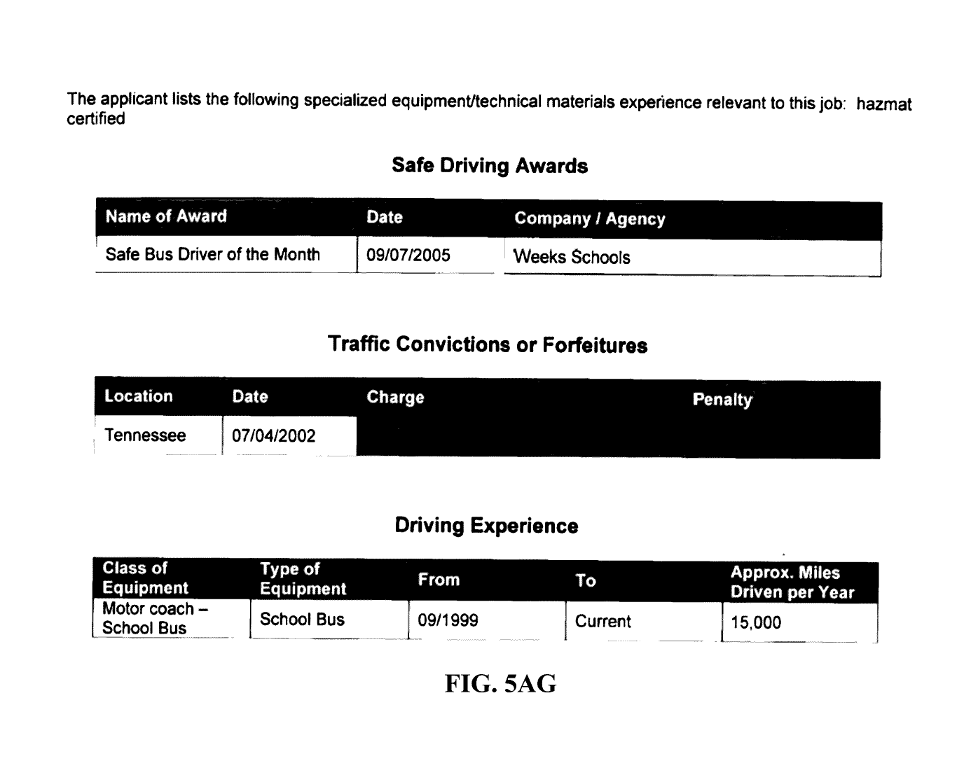

Furthermore, an exemplary narrative report generated by virtue of the system 10 is illustrated in FIGS. 5A-5AG. In particular, the report is automatically generated based upon the questions asked and the answers provided.

Other information can be used to generate the report or narrative, including, for example, scoring or assessing veracity or candidness by calculating and/or assessing one or more metrics related to the responses to the questions provided by the biodata question database 16. For example, the system 10 may monitor or calculate the time it takes for the applicant to answer some or all of the questions. In addition, the questions/answers may be provided, selected, generated or scored based upon, for example, a social desirability scale to determine the applicant's defensiveness style. Other embodiments may analyze the time it takes for an applicant to answer one or more questions, and based thereon, develop a score or analysis. For example, in the event the applicant takes longer than a predetermined amount of time to answer some questions (e.g., legal questions, legal history, criminal history, etc.) there may be an inference or determination that the application may be overly concerned about that question.

Some embodiments will forbid or prevent the application from going back in the application to review or revise previously submitted answers. Thus, in the event similar subsequent questions arise, the applicant cannot go back and review his previous answer. Comparison of certain answers (e.g., whether answers provided in similar questions are consistent) may be used to determine a level of deception or honesty in the answers. Some embodiments may prevent the applicant from stopping and restarting the application process, while other embodiments may allow the application to stop at any time, and return at any time to complete the questions or application. Furthermore, some embodiments may analyze the answers provided and automatically generate proposed or suggested interview questions for the company representative to ask during an interview, for example, during a live, telephone, or webcast interview.

As an example, the narrative or report can include some of all of the following components or parts: Introduction (FIG. 5A), Application Summary (FIGS. 5B through 5I) including illegal drug use, Employment History and related information (FIGS. 5J though 5W), Educational History (FIGS. 5X through 5Y), Military History (FIG. 5Z), Residential History (FIG. 5AA), Legal History (FIGS. 5AB through 5AC), Financial History (FIG. 5AD) and Driving Record History (FIGS. 5AE through 5AG).

The system 10 assigns specific scores to certain behavioral attributes elicited by and/or provided in response to the various biodata questions, which allows the system to generate a narrative report that includes representations of the applicant's ability to take responsibility for their own behavior and identify the impact of inappropriate workplace behavior. The unique scoring result and narrative output can be presented in a color-coded table, for example, that provides a highly visual data set representation. For example, FIGS. 5N-5O show illustrations of examples of these unique scoring tables generated by the system 10.

Referring to FIG. 5N, the biodata questions presented to the applicant included both self-assessments as well as what others would assess for the applicant's prior job performance. In this example, the biodata questions sought responses related to “Job Self-Rating,” “Expected Supervisor Rating,” and “Perceived Supervisor Accuracy Summary.” The multiple-choice responses provided for the applicant's selection may include responses indicating a spectrum of ratings, including “Superior,” “Above Average,” “Average,” “Below Average,” for the job ratings, and “Mostly Accurate,” “Somewhat Inaccurate,” and “Very Inaccurate” for the perceived supervisor accuracy summary. Each of these optional responses may have a predetermined numerical value or score associated with it (e.g., 5, 4, 3, 2, 1), and these scored responses can be analyzed, tabulated, or used to calculate a rating indicative of potential problems, e.g., “No Problems,” “Moderate Problems,” and “Significant Problems.” The rating may be calculated in several different ways. For example, the individual scores for the selected row of responses (e.g., “ABC Distributing”) may be added together, then compared to predetermined, predefined threshold values to determine the particular rating (e.g., if the row total is more than 10, then the rating is “Significant Problems,” if the row total is between 5 and 9, then the rating is “Moderate Problems,” etc.). The rating may also include totaling the scores along the columns of the table, averaging one or more of the scored responses, and/or calculating a difference between individual scores to generate a rating (e.g., if the “Self-Rating” response varies greatly from the “Expected Supervisor Rating” response, then the rating will be weighted or adjusted accordingly).

Referring to FIG. 5O, the biodata questions presented to the applicant included a behavioral characteristic, such as temper, and included variations of both self-assessment as well as what others would assess for the applicant. In this example, the biodata questions sought responses related to “Temper Self-Rating,” “Expected Supervisor Rating of Temper,” and “Expected Co-Worker Rating of Temper.” The multiple-choice responses provided for the applicant's selection may include responses indicating a spectrum of behavior ratings, including “No difficulty controlling temper,” “Occasional verbally loud,” “Easily angered with no intent to be violent,” “Reprimanded for temper,” and “Terminated for temper.” Each of these optional responses may have a predetermined numerical value or score associated with it (e.g., 5, 4, 3, 2, 1), and these scored responses can be analyzed, tabulated, or used to calculate a rating indicative of potential problems, e.g., “No Problems,” “Moderate Problems,” and “Significant Problems.” The rating may be calculated in several different ways. For example, the individual scores for the selected row of responses (e.g., “ABC Distributing”) may be added together, then compared to predetermined, predefined threshold values to determine the particular rating (e.g., if the row total is more than 10, then the rating is “Significant Problems,” if the row total is between 5 and 9, then the rating is “Moderate Problems,” etc.). The rating may also include totaling the scores along the columns of the table, averaging one or more of the scored responses, and/or calculating a difference between individual scores to generate a rating (e.g., if the “Self-Rating” response varies greatly from the “Expected Supervisor Rating” response, then the rating will be weighted or adjusted accordingly).

As discussed above, the system 10 may score or assess veracity or candidness in the responses provided by an applicant to the biodata questions. The system 10 may conduct such analysis to establish or provide an indication of whether the applicant is being candid during this process or if they are attempting to present themselves in an unreasonably favorable light. This information is not only informative in the narrative generated by the system 10, but can also help guide any subsequent in-person interview process.

The veracity or candidness scoring and/or assessment may include a response time component. For example, an applicant's response to a specific biodata question may be compared to his response time for a different biodata question, with any significant variation between the two response times indicating or being scored as a potentially untruthful or less-than-candid response. Alternative methods of employing the response time as a veracity or candidness indicator may include comparing a specific biodata question response time to an average response time that the applicant took for each of a plurality of other biodata questions; may include comparing a specific biodata question response time for an applicant to the average response time of other applicants for that same biodata question; and/or may include comparing a specific biodata question response time for an applicant to a predefined threshold time limit for a response. The outcome of the time-based veracity or candidness scoring or assessment may be implemented into determining subsequent biodata questions to present to the applicant to further investigate and elicit responses for the topic or category of biodata questions that have been indicated as potentially untruthful.

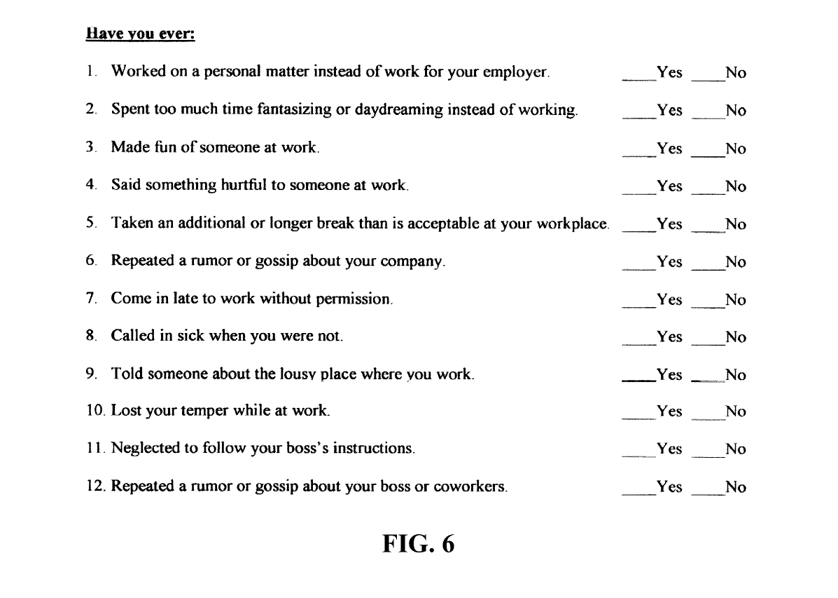

The veracity or candidness scoring and/or assessment may include an analysis of predetermined scores assigned to one or more of an applicant's provided response. For example, FIG. 6 includes examples of biodata questions constituting a “Social Desirability Scale” that can be used to determine the overall candidness or veracity of an applicant's responses. The Social Desirability Scale measures the applicant's defensive attitude, and helps ascertain if the applicant is willing to admit to common behaviors in the workplace or deny those behaviors in an attempt to appear unrealistically virtuous. That is, responses to the questions in the Social Desirability Scale indicate whether the applicant will admit to minor flaws or try to present themselves as “perfect”. This tendency to present oneself as having no flaws aids in informing the hiring manager as to the attitude of the applicant in the hiring interview.

The Social Desirability Scale concerns pro-social expected work behaviors that workers acknowledge are inappropriate in the workplace. The example of the questions presented in FIG. 6 may include a scoring format of “true” or “false.” That is, if the applicant answers “true” for the item, this endorsement means the applicant acknowledges having engaged in this undesirable behavior. For example, the question is “Come in late to work without permission”. If the applicant answers “True”, this is an acknowledgement that they have violated a work rule. If they answer “False”, the applicant denies they have ever “Come in late to work without permission”. All items on the Social Desirability Scale are scored in the “False” direction. The “False” answer is one of denying ever having engaged in inappropriate behavior in the workplace.

In order to evaluate if the Social Desirability (SD) scale is actually measuring what it claims (that some applicants will deny “negative” behaviors that most people admit to), the SD scale was statistically analyzed to determine the correlation coefficient between the SD scale and the L(lie) scale of the MMPI-2. The MMPI-2 is the most widely used psychological test in the world. The L scale is not a “clinical” scale. It does not contribute to a diagnosis. The 15 items of the L scale are all scored in the False direction as are the items on the SD scale. The range (1-12) of “false” answers on the SD scale inform the Smart-Applicant reviewer about the person's defensive attitude. Thus, the SD scale and the L scale are purported to measure the concept of “social desirability”. In order to validate this, the Pearson product-moment correlation coefficient was calculated (see below).

$${ρ}_{X , Y} = \frac{E [ ( X - {μ}_{X} ) ( Y - {μ}_{Y} ) ]}{{σ}_{X} {σ}_{Y}}$$

It is a measure of the strength of a linear association between two variables and is denoted as r. The “r” can take a range of values from +1 to 0 to −1. A value greater than 0 indicates a positive relationship between the two measures. For example, an “r” of 1.00 equals a perfect, linear relation. As one measure goes up, the other measure goes up in the same direction on all items. A “r” of 0 indicates there is no relationship between the two variables. If measure A goes up, measure B may go up or go down in an unpredictable fashion. An “r” value of −1.0 means that if measure A goes up in value, measure B always goes down an equal amount in value in a linear fashion.

The Pearson Correlation Coefficient r value of 0.81 on the SD scale indicates a very strong positive relationship between the items on the SD scale and the L scale. In other words, the SD scale measures the same concepts (denial of inappropriate social behavior) as the L scale.

The veracity or candidness scoring and/or assessment may include an analysis of a response to a first biodata question to a response provided to a second biodata question. For example, if multiple biodata questions are presented that relate to a common topic, such as employment termination, but the answers provided appear to contradict each other or lack a strong correlation, then these discrepancies can be assessed as an indicator of veracity or candidness.

The systems and methods described herein provide unique properties that allow hiring managers to increase the probability of a good hiring decision. Additionally, a Social Desirability scale psychometrically measures the applicant's willingness to be candid and straightforward when answering the questions on the application. The system 10 and methods of use thereof thus can detect, and report on, a candidate's conscious and volitional attempt to present him/her self in an unrealistically virtuous manner. This greatly enhances the hiring manager's ability to distinguish between those candidates that are straightforwardly supplying information to the system 10 and those candidates who chose to intentionally distort their answers in an attempt to likely hide negative behaviors that would influence the hiring decision.

Additionally, the narrative report and scoring provided by the system 10 may be used as a basis to provide a further indicator or rating for an applicant's eligibility for various positions as set forth and described by the O*Net. The O*Net was created by the U.S. Department of Labor to describe the knowledge, skills and abilities of over 1,100 job categories. The system 10 may compare the ratings and scoring assessed and provided from an applicant's responses to the biodata questions to the O*Net knowledge, skills and abilities requirements, and further generate a score or indication of a correlation (or lack thereof) of an applicant's attributes and behavioral indicators to the O*Net requirements.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device such as magnetic storage, semiconductor memory, DVD, Compact Disk or memory stick.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

Program code may be transmitted to a computer constructed in accordance with the principles of the present invention using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. It is noted that the computer programs of the present invention can be downloaded via the Internet to a computer, such as network device and/or target host system, having a TCP/IP-based network adapter card for installation in the computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The term “computer-readable storage device” does not encompass a signal propagation media such as a copper cable, optical fiber or wireless transmission media.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A computer-based method for acquiring and assessing applicant biodata, comprising:
presenting a first biodata question to an applicant;
receiving a response to the first biodata question from the applicant;
presenting a second biodata question to the applicant, wherein the second biodata question is selected from a plurality of stored biodata questions, and wherein the selection is based at least in part on the applicant's response to the first biodata question;
receiving a response to the second biodata question from the applicant; and
calculating a candidness score for each of the responses to the first and second biodata question, wherein the calculation is based at least in part on at least one of i) a time duration for the applicant to respond; ii) a predetermined score assigned to an applicant's provided response; and iii) a comparison between the response to the first biodata question and the response to the second biodata question.

2. The method of claim 1, wherein presenting the first biodata questions includes transmission of the first biodata question across a network, and wherein receiving the response includes receiving information transmitted across the network.

3. The method of claim 1, wherein the first and second biodata questions each refer to at least one of employment history, educational history, residential history, military history, legal history, and financial history.

4. The method of claim 1, further comprising generating a narrative report based at least in part on the responses to the first and second biodata questions and the candidness score.

5. The method of claim 1, wherein presenting each of the first and second biodata questions includes presenting a plurality of predetermined answers for the applicant to select.

6. The method of claim 5, wherein each of the predetermined answers has an assigned scoring value different from each of the other predetermined answers.

7. The method of claim 6, wherein calculating a candidness score based at least in part on a comparison between the responses to the first and second biodata questions includes comparing whether the assigned scoring value for the response to the first biodata question matches the assigned scoring value for the response to the second biodata questions.

8. The method of claim 7, further comprising generating a narrative report based at least in part on the assigned scoring value for each of the selected responses to the first and second biodata questions.

9. The method of claim 1, wherein calculating the candidness score includes calculating i) a time duration for the applicant to respond; ii) a predetermined score assigned to an applicant's provided response; and iii) a comparison between the response to the first biodata question and the response to the second biodata question.

10. The method of claim 1, wherein calculating a candidness score based at least in part on a time duration for the applicant to respond includes:
calculating an average response time across a plurality of biodata questions; and
comparing a response time the applicant takes for a specific biodata question to the calculated average response time.

11. The method of claim 1, wherein calculating a candidness score based at least in part on a time duration for the applicant to respond includes comparing a response time the applicant takes for a specific biodata question to a predefined response time threshold.

12. A system for acquiring and assessing applicant biodata, comprising:
a biodata question database storing a plurality of biodata questions;
a user interface in communication with the biodata question database, the user interface configured to present biodata questions to an applicant and receive responses to the biodata questions from the applicant; and
a processor in communication with the user interface and the biodata question database, wherein the processor is programmed to:
select a first biodata question for presentation to the applicant;
receive a response to the first biodata question from the applicant;
select a second biodata question for presentation to the applicant, wherein the second biodata question is selected from the plurality of stored biodata questions, and wherein the selection is based at least in part on the applicant's response to the first biodata question;
receive a response to the second biodata question from the applicant; and
calculate a candidness score for each of the responses to the first and second biodata question, wherein the calculation is based at least in part on at least one of i) a time duration for the applicant to respond; ii) a predetermined score assigned to an applicant's provided response; and iii) a comparison between the response to the first biodata question and the response to the second biodata question.

13. The system of claim 12, wherein the first and second biodata questions each refer to at least one of employment history, educational history, residential history, military history, legal history, and financial history.

14. The system of claim 12, wherein the processor is programmed to generate a narrative report based at least in part on the responses to the first and second biodata questions and the candidness score.

15. The system of claim 12, wherein presenting each of the first and second biodata questions includes presenting a plurality of predetermined answers for the applicant to select.

16. The system of claim 15, wherein each of the predetermined answers has an assigned scoring value different from each of the other predetermined answers.

17. The system of claim 16, wherein calculating a candidness score based at least in part on a comparison between the responses to the first and second biodata questions includes comparing whether the assigned scoring value for the response to the first biodata question matches the assigned scoring value for the response to the second biodata questions.

18. The system of claim 17, wherein the processor is programmed to generate a narrative report based at least in part on the assigned scoring value for each of the selected responses to the first and second biodata questions.

19. The system of claim 12, wherein calculating the candidness score includes calculating i) a time duration for the applicant to respond; ii) a predetermined score assigned to an applicant's provided response; and iii) a comparison between the response to the first biodata question and the response to the second biodata question.

20. The system of claim 12, wherein calculating a candidness score based at least in part on a time duration for the applicant to respond includes:
calculating an average response time across a plurality of biodata questions; and comparing a response time the applicant takes for a specific biodata question to the calculated average response time.
